(19) United States
(12) Patent Application Publication
(10) Pub. No.: US 2010/0053820 A1
(43) Pub. Date: Mar. 4, 2010

(54) Magnetoresistive element including a pair of ferromagnetic layers coupled to a pair of shield layers

(75) Inventors: Daisuke Miyauchi, Tokyo (JP); Yoshihiro Tsuchiya, Tokyo (JP); Tsutomu Chou, Tokyo (JP); Shinji Hara, Tokyo (JP); Takahiko Machita, Tokyo (JP); Koji Shimazawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/230,604

(22) Filed: Sep. 2, 2008

(51) Int. Cl. G11B 5/33

(52) U.S. Cl. 360/319; G9B/5.104

(57) ABSTRACT

A magnetoresistive element includes first and second shield layers, an MR stack disposed therebetween, a first hard magnetic layer for setting the magnetization direction of the first shield layer, and a second hard magnetic layer for setting the magnetization direction of the second shield layer. The MR stack includes a first ferromagnetic layer magnetically coupled to the first shield layer, a second ferromagnetic layer magnetically coupled to the second shield layer, and a spacer layer between the first and second ferromagnetic layers. The first and second ferromagnetic layers have magnetizations that are in antiparallel directions when any external magnetic field other than a magnetic field resulting from the first and second hard magnetic layers is not applied to the two ferromagnetic layers, and that change their directions in response to an external magnetic field other than the magnetic field resulting from the first and second hard magnetic layers.

### BACKGROUND OF THE INVENTION

1. Field of the Invention

The present invention relates to a magnetoresistive element, and to a thin-film magnetic head, a head assembly and a magnetic disk drive each including the magnetoresistive element.

2. Description of the Related Art

Performance improvements in thin-film magnetic heads have been sought as areal recording density of magnetic disk drives has increased. A widely used type of thin-film magnetic head is a composite thin-film magnetic head that has a structure in which a write head having an induction-type electromagnetic transducer for writing and a read head having a magnetoresistive element (hereinafter, also referred to as MR element) for reading are stacked on a substrate.

Examples of MR elements include GMR (giant magnetoresistive) elements utilizing a giant magnetoresistive effect, and TMR (tunneling magnetoresistive) elements utilizing a tunneling magnetoresistive effect.

Read heads are required to have characteristics of high sensitivity and high output. As the read heads that satisfy such requirements, those incorporating spin-valve GMR elements or TMR elements have been mass-produced.

Spin-valve GMR elements and TMR elements each typically include a free layer, a pinned layer, a spacer layer disposed between the free layer and the pinned layer, and an antiferromagnetic layer disposed on a side of the pinned layer farther from the spacer layer. The free layer is a ferromagnetic layer having a magnetization that changes its direction in response to a signal magnetic field. The pinned layer is a ferromagnetic layer having a magnetization in a fixed direction. The antiferromagnetic layer is a layer that fixes the direction of the magnetization of the pinned layer by means of exchange coupling with the pinned layer. The spacer layer is a nonmagnetic conductive layer in spin-valve GMR elements, or is a tunnel barrier layer in TMR elements.

Examples of read heads incorporating GMR elements include those having a CIP (current-in-plane) structure in which a current used for detecting a signal magnetic field (hereinafter referred to as a sense current) is fed in the direction parallel to the planes of the layers constituting the GMR element, and those having a CPP (current-perpendicular-to-plane) structure in which the sense current is fed in a direction intersecting the planes of the layers constituting the GMR element, such as the direction perpendicular to the planes of the layers constituting the GMR element.

Read heads each incorporate a pair of shields sandwiching the MR element. The distance between the two shields is called a read gap length. Recently, with an increase in recording density, there have been increasing demands for a reduction in track width and a reduction in read gap length in read heads.

As an MR element capable of reducing the read gap length, there has been proposed an MR element including two ferromagnetic layers each functioning as a free layer, and a spacer layer disposed between the two ferromagnetic layers (such an MR element is hereinafter referred to as an MR element of the three-layer structure), as disclosed in U.S. Pat. No. 7,035,062 B1, for example. In the MR element of the three-layer structure, the two ferromagnetic layers have magnetizations that are in directions antiparallel to each other and parallel to the track width direction when no external magnetic field is applied to those ferromagnetic layers, and that change their directions in response to an external magnetic field.

In a read head incorporating an MR element of the three-layer structure, a bias magnetic field is applied to the two ferromagnetic layers. The bias magnetic field changes the directions of the magnetizations of the two ferromagnetic layers so that each of the directions forms an angle of approximately 45 degrees with respect to the track width direction. As a result, the directions of the magnetizations of the two ferromagnetic layers form a relative angle of approximately 90 degrees. When a signal magnetic field sent from the recording medium is applied to the read head, the relative angle between the directions of the magnetizations of the two ferromagnetic layers changes, and as a result, the resistance of the MR element changes. For this read head, it is possible to detect the signal magnetic field by detecting the resistance of the MR element. The read head incorporating an MR element of the three-layer structure allows a much greater reduction in read gap length, compared with a read head incorporating a conventional GMR element.

For an MR element of the three layer structure, one of methods for directing the magnetizations of the two ferromagnetic layers antiparallel to each other when no external magnetic field is applied thereto is to antiferromagnetically couple the two ferromagnetic layers to each other by the RKKY interaction through the spacer layer.

Disadvantageously, however, this method imposes limitation on the material and thickness of the spacer layer to allow antiferromagnetic coupling between the two ferromagnetic layers. In addition, since this method limits the material of the spacer layer to a nonmagnetic conductive material, it is not applicable to a TMR element that is expected to have a high output, or a GMR element of a current-confined-path type CPP structure, which is an MR element also expected to have a high output and having a spacer layer that includes a portion allowing the passage of currents and a portion intercepting the passage of currents. The above-described method further has a disadvantage that, even if it could be possible to direct the magnetizations of the two ferromagnetic layers antiparallel to each other, it is difficult to direct those magnetizations parallel to the track width direction with reliability.

U.S. Pat. No. 6,169,647 B1 discloses a method of weakly fixing the directions of the magnetizations of the two ferromagnetic layers of an MR element of the three-layer structure so that the magnetizations of the two ferromagnetic layers are directed antiparallel to each other, through the use of two antiferromagnetic layers disposed on the respective sides of the two ferromagnetic layers farther from the spacer layer.

However, this method has a disadvantage that a reduction in read gap length is difficult due to the presence of the two antiferromagnetic layers. In addition, while this method requires that the exchange coupling magnetic fields generated from the two antiferromagnetic layers be directed antiparallel to each other, it is very difficult to subject the two antiferromagnetic layers to such a heat treatment (annealing) that this requirement can be satisfied.

### OBJECT AND SUMMARY OF THE INVENTION

It is an object of the present invention to provide a magnetoresistive element including two ferromagnetic layers whose magnetizations change their directions in response to an external magnetic field, and a spacer layer disposed between the two ferromagnetic layers, the magnetoresistive element being capable of directing the magnetizations of the two ferromagnetic layers antiparallel to each other when no external magnetic field is applied, without making use of antiferromagnetic coupling between the two ferromagnetic layers through the spacer layer, and to provide a thin-film magnetic head, a head assembly and a magnetic disk drive each including such a magnetoresistive element.

A magnetoresistive element of the present invention includes a first shield layer, a second shield layer, an MR stack disposed between the first and second shield layers, a first hard magnetic layer for setting a magnetization direction of the first shield layer, and a second hard magnetic layer for setting a magnetization direction of the second shield layer. The MR stack includes a first ferromagnetic layer magnetically coupled to the first shield layer, a second ferromagnetic layer magnetically coupled to the second shield layer, and a spacer layer made of a nonmagnetic material and disposed between the first and second ferromagnetic layers. The first and second ferromagnetic layers have magnetizations that are in directions antiparallel to each other when any external magnetic field other than a magnetic field resulting from the first and second hard magnetic layers is not applied to the first and second ferromagnetic layers, and that change their directions in response to an external magnetic field other than the magnetic field resulting from the first and second hard magnetic layers.

In the magnetoresistive element of the present invention, the first hard magnetic layer may include two portions disposed on two sides of the first shield layer, the two sides being opposite to each other in a direction orthogonal to a direction in which the layers constituting the MR stack are stacked. In this case, the first shield layer and the two portions of the first hard magnetic layer may be aligned in a first direction, and the two portions of the first hard magnetic layer may have magnetizations in the same direction parallel to the first direction. The second hard magnetic layer may include two portions disposed on two sides of the second shield layer, the two sides being opposite to each other in the direction orthogonal to the direction in which the layers constituting the MR stack are stacked. In this case, the second shield layer and the two portions of the second hard magnetic layer may be aligned in a second direction, and the two portions of the second hard magnetic layer may have magnetizations in the same direction parallel to the second direction.

The magnetoresistive element of the present invention may further include: a first closed-magnetic-path-forming portion that magnetically couples respective ends of the two portions of the first hard magnetic layer, the ends being located farther from the first shield layer, and forms a first closed magnetic path together with the first shield layer and the two portions of the first hard magnetic layer; and a second closed-magnetic-path-forming portion that magnetically couples respective ends of the two portions of the second hard magnetic layer, the ends being located farther from the second shield layer, and forms a second closed magnetic path together with the second shield layer and the two portions of the second hard magnetic layer.

In the magnetoresistive element of the present invention, the magnetization direction of the first shield layer and the magnetization direction of the second shield layer may be the same. In this case, one of the coupling between the first shield layer and the first ferromagnetic layer and the coupling between the second shield layer and the second ferromagnetic layer may be such coupling that the magnetizations of the two coupled layers are in the same direction, while the other may be such coupling that the magnetizations of the two coupled layers are in directions antiparallel to each other. In this case, the magnetoresistive element may further include: a first coupling layer disposed between the first shield layer and the first ferromagnetic layer and magnetically coupling the first shield layer and the first ferromagnetic layer to each other; and a second coupling layer disposed between the second shield layer and the second ferromagnetic layer and magnetically coupling the second shield layer and the second ferromagnetic layer to each other. At least one of the first coupling layer and the second coupling layer may include a nonmagnetic layer and two magnetic layers sandwiching the nonmagnetic layer.

The magnetoresistive element of the present invention may further include a bias magnetic field applying layer that applies a bias magnetic field to the first and second ferromagnetic layers so that the magnetizations of the first and second ferromagnetic layers change their directions compared with a state in which no bias magnetic field is applied to the first and second ferromagnetic layers. In this case, the bias magnetic field applying layer may include a third ferromagnetic layer and an antiferromagnetic layer that are stacked and are exchange-coupled to each other. In addition, in this case, the bias magnetic field applying layer may apply the bias magnetic field to the first and second ferromagnetic layers so that the magnetizations of the first and second ferromagnetic layers are directed orthogonal to each other.

A thin-film magnetic head of the present invention includes: a medium facing surface that faces toward a recording medium; and the magnetoresistive element of the invention disposed near the medium facing surface to detect a signal magnetic field sent from the recording medium.

A head assembly of the present invention includes: a slider including the thin-film magnetic head of the invention and disposed to face toward the recording medium; and a supporter flexibly supporting the slider.

A magnetic disk drive of the present invention includes: a slider including the thin-film magnetic head of the invention and disposed to face toward a recording medium that is driven to rotate; and an alignment device supporting the slider and aligning the slider with respect to the recording medium.

According to the present invention, the magnetization direction of the first shield layer is set by the first hard magnetic layer, the magnetization direction of the second shield layer is set by the second hard magnetic layer, the first ferromagnetic layer is magnetically coupled to the first shield layer, and the second ferromagnetic layer is magnetically coupled to the second shield layer. The magnetizations of the two ferromagnetic layers are thereby directed antiparallel to each other when no external magnetic field is applied. According to the present invention, it is thus possible to direct the magnetizations of the two ferromagnetic layers antiparallel to each other when no external magnetic field is applied, without making use of antiferromagnetic coupling between the two ferromagnetic layers through the spacer layer.

According to the present invention, the first hard magnetic layer may include two portions disposed on two sides of the first shield layer, the two sides being opposite to each other in a direction orthogonal to the direction in which the layers constituting the MR stack are stacked, while the second hard magnetic layer may include two portions disposed on two sides of the second shield layer, the two sides being opposite to each other in the direction orthogonal to the direction in which the layers constituting the MR stack are stacked, and the magnetoresistive element may further include the first and second closed-magnetic-path-forming portions. In this case, it becomes possible that the magnetization directions of the first and second shield layers are efficiently set by the first and second hard magnetic layers without generation of any unwanted leakage magnetic field.

Other and further objects, features and advantages of the present invention will appear more fully from the following description.

### BRIEF DESCRIPTION OF THE DRAWINGS

FIG. 1 is a cross-sectional view showing a cross section of a magnetoresistive element of an embodiment of the invention parallel to the medium facing surface.

FIG. 2 is an enlarged cross-sectional view of a portion of the magnetoresistive element of FIG. 1.

FIG. 3 is an enlarged cross-sectional view of the MR stack of FIG. 2.

FIG. 4 is a top view of a main part of the magnetoresistive element of FIG. 1.

FIG. 5 is a cross-sectional view showing a cross section of the magnetoresistive element of FIG. 1 perpendicular to the medium facing surface and the top surface of the substrate.

FIG. 6 is a cross-sectional view showing the configuration of a thin-film magnetic head of the embodiment of the invention.

FIG. 7 is a front view showing the medium facing surface of the thin-film magnetic head of the embodiment of the invention.

FIG. 8A and FIG. 8B are illustrative views showing a step of a method of manufacturing the magnetoresistive element of the embodiment of the invention.

FIG. 9A and FIG. 9B are illustrative views showing a step that follows the step of FIG. 8A and FIG. 8B.

FIG. 10A and FIG. 10B are illustrative views showing a step that follows the step of FIG. 9A and FIG. 9B.

FIG. 11A and FIG. 11B are illustrative views showing a step that follows the step of FIG. 10A and FIG. 10B.

FIG. 12A and FIG. 12B are illustrative views showing a step that follows the step of FIG. 11A and FIG. 11B.

FIG. 13A and FIG. 13B are illustrative views showing a step that follows the step of FIG. 12A and FIG. 12B.

FIG. 14A and FIG. 14B are illustrative views showing a step that follows the step of FIG. 13A and FIG. 13B.

FIG. 15A and FIG. 15B are illustrative views showing a step that follows the step of FIG. 14A and FIG. 14B.

FIG. 16A and FIG. 16B are illustrative views showing a step that follows the step of FIG. 15A and FIG. 15B.

FIG. 17A and FIG. 17B are illustrative views showing a step that follows the step of FIG. 16A and FIG. 16B.

FIG. 18 is an illustrative view for explaining the operation of the magnetoresistive element of the embodiment of the invention.

FIG. 19 is an illustrative view for explaining the operation of the magnetoresistive element of the embodiment of the invention.

FIG. 20 is an illustrative view for explaining the operation of the magnetoresistive element of the embodiment of the invention.

FIG. 21 is a plot showing the relationship between the thickness of a metal gap layer and the flux density of a biased shield layer in the magnetoresistive element of FIG. 1.

FIG. 22 is a perspective view showing the configuration of a magnetoresistive element of First Comparative Example.

FIG. 23 is an illustrative view for explaining asymmetry of a read output waveform of a magnetoresistive element.

FIG. 24 is a perspective view of a slider including the thin-film magnetic head of the embodiment of the invention.

FIG. 25 is a perspective view of a head arm assembly of the embodiment of the invention.

FIG. 26 is an illustrative view for illustrating a main part of a magnetic disk drive of the embodiment of the invention.

FIG. 27 is a top view of the magnetic disk drive of the embodiment of the invention.

### DETAILED DESCRIPTION OF THE PREFERRED EMBODIMENT

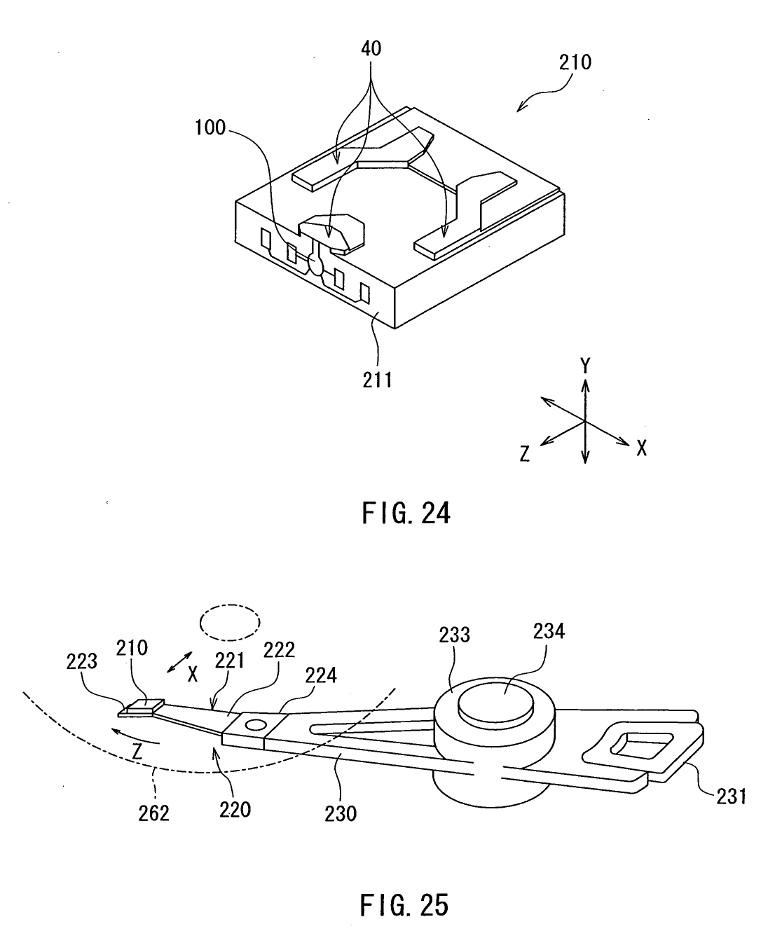

An embodiment of the present invention will now be described in detail with reference to the drawings. Reference is first made to FIG. 24 to describe a slider 210 including a thin-film magnetic head of the embodiment of the invention. In a magnetic disk drive, the slider 210 is placed to face toward a circular-plate-shaped recording medium (a magnetic disk platter) that is to be driven to rotate. In FIG. 24, the X direction is across the tracks of the recording medium, the Y direction is perpendicular to the surface of the recording medium, and the Z direction is the direction of travel of the recording medium as seen from the slider 210. The X, Y and Z directions are orthogonal to one another. The slider 210 has a base body 211. The base body 211 is nearly hexahedron-shaped. One of the six surfaces of the base body 211 is designed to face toward the surface of the recording medium. At this one of the six surfaces, there is formed a medium facing surface 40 to face toward the recording medium. When the recording medium rotates and travels in the Z direction, an airflow passing between the recording medium and the slider 210 causes a lift below the slider 210 in the Y direction of FIG. 24. This lift causes the slider 210 to fly over the surface of the recording medium. The thin-film magnetic head 100 of the present embodiment is formed near the air-outflow-side end (the end located at the lower left of FIG. 24) of the slider 210.

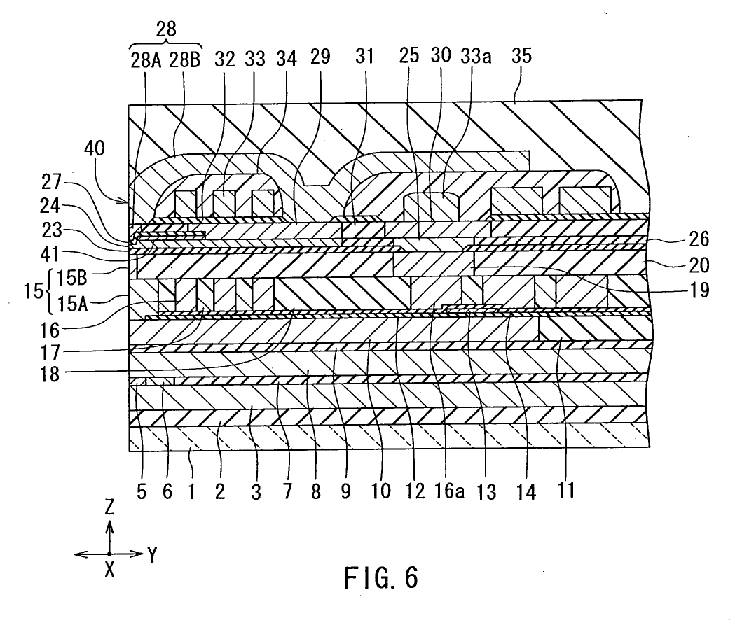

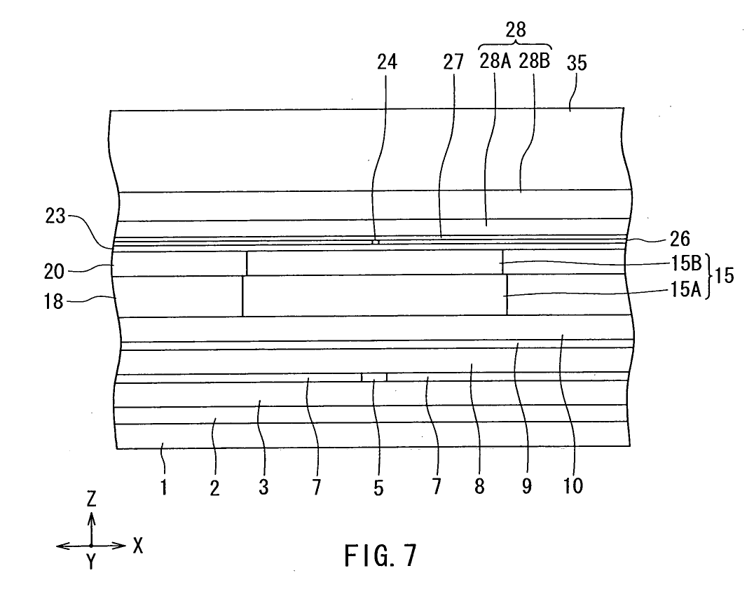

Reference is now made to FIG. 6 and FIG. 7 to describe the configuration of the thin-film magnetic head of the present embodiment. FIG. 6 is a cross-sectional view showing the configuration of the thin-film magnetic head. FIG. 7 is a front view showing the medium facing surface of the thin-film magnetic head. Note that FIG. 6 shows a cross section perpendicular to the medium facing surface and the top surface of the substrate. The X, Y and Z directions shown in FIG. 24 are also shown in FIG. 6 and FIG. 7. In FIG. 6 the X direction is orthogonal to the Y and Z directions. In FIG. 7 the Y direction is orthogonal to the X and Z directions.

As shown in FIG. 6, the thin-film magnetic head of the present embodiment has the medium facing surface 40 that faces toward the recording medium. As shown in FIG. 6 and FIG. 7, the thin-film magnetic head includes: a substrate 1 made of a ceramic material such as aluminum oxide-titanium carbide (Al₂O₃—TiC); an insulating layer 2 made of an insulating material such as alumina (Al₂O₃) and disposed on the substrate 1; a first read shield portion 3 disposed on the insulating layer 2; and an MR stack 5, a bias magnetic field applying layer 6 and an insulating layer 7 that are disposed on the first read shield portion 3.

The MR stack 5 has a bottom surface touching the first read shield portion 3, a top surface opposite to the bottom surface, a front end face located in the medium facing surface 40, a rear end face opposite to the front end face, and two side surfaces that are opposed to each other in the track width direction (the X direction of FIG. 7). The bias magnetic field applying layer 6 is disposed adjacent to the rear end face of the MR stack 5, with an insulating film (not shown) provided between the MR stack 5 and the layer 6. The insulating layer 7 is disposed around the MR stack 5 and the bias magnetic field applying layer 6.

The thin-film magnetic head further includes: a second read shield portion 8 disposed on the MR stack 5, the bias magnetic field applying layer 6 and the insulating layer 7; and a separating layer 9 made of a nonmagnetic material such as alumina and disposed on the second read shield portion 8.

The portion from the first read shield portion 3 to the second read shield portion 8 constitutes a magnetoresistive element (hereinafter referred to as MR element) of the present embodiment. The MR element constitutes a read head of the thin-film magnetic head of the present embodiment. The configuration of the MR element will be described in detail later.

The thin-film magnetic head further includes: a magnetic layer 10 made of a magnetic material and disposed on the separating layer 9; and an insulating layer 11 made of an insulating material such as alumina and disposed around the magnetic layer 10. The magnetic layer 10 has an end face located in the medium facing surface 40. The magnetic layer 10 and the insulating layer 11 have flattened top surfaces.

The thin-film magnetic head further includes: an insulating film 12 disposed on the magnetic layer 10 and the insulating layer 11; a heater 13 disposed on the insulating film 12; and an insulating film 14 disposed on the insulating film 12 and the heater 13 such that the heater 13 is sandwiched between the insulating films 12 and 14. The function and material of the heater 13 will be described later. The insulating films 12 and 14 are made of an insulating material such as alumina.

The thin-film magnetic head further includes a first write shield 15 disposed on the magnetic layer 10. The first write shield 15 includes: a first layer 15A disposed on the magnetic layer 10; and a second layer 15B disposed on the first layer 15A. The first layer 15A and the second layer 15B are made of a magnetic material. Each of the first layer 15A and the second layer 15B has an end face located in the medium facing surface 40. In the example shown in FIG. 6, the length of the second layer 15B taken in the direction perpendicular to the medium facing surface 40 (the Y direction of FIG. 6) is smaller than the length of the first layer 15A taken in the direction perpendicular to the medium facing surface 40. However, the length of the second layer 15B taken in the direction perpendicular to the medium facing surface 40 may be equal to or greater than the length of the first layer 15A taken in the direction perpendicular to the medium facing surface 40.

The thin-film magnetic head further includes: a coil 16 made of a conductive material and disposed on the insulating film 14; an insulating layer 17 that fills the space between the coil 16 and the first layer 15A and the space between every adjacent turns of the coil 16; and an insulating layer 18 disposed around the first layer 15A, the coil 16 and the insulating layer 17. The coil 16 is planar spiral-shaped. The coil 16 includes a connecting portion 16a that is a portion near an inner end of the coil 16 and connected to another coil described later. The insulating layer 17 is made of photoresist, for example. The insulating layer 18 is made of alumina, for example. The first layer 15A, the coil 16, the insulating layer 17 and the insulating layer 18 have flattened top surfaces.

The thin-film magnetic head further includes: a connecting layer 19 made of a conductive material and disposed on the connecting portion 16a; and an insulating layer 20 made of an insulating material such as alumina and disposed around the second layer 15B and the connecting layer 19. The connecting layer 19 may be made of the same material as the second layer 15B. The second layer 15B, the connecting layer 19 and the insulating layer 20 have flattened top surfaces.

The thin-film magnetic head further includes a first gap layer 23 disposed on the second layer 15B, the connecting layer 19 and the insulating layer 20. The first gap layer 23 has an opening formed in a region corresponding to the top surface of the connecting layer 19. The first gap layer 23 is made of a nonmagnetic insulating material such as alumina.

The thin-film magnetic head further includes: a pole layer 24 made of a magnetic material and disposed on the first gap layer 23; a connecting layer 25 made of a conductive material and disposed on the connecting layer 19; and an insulating layer 26 made of an insulating material such as alumina and disposed around the pole layer 24 and the connecting layer 25. The pole layer 24 has an end face located in the medium facing surface 40. The connecting layer 25 is connected to the connecting layer 19 through the opening of the first gap layer 23. The connecting layer 25 may be made of the same material as the pole layer 24.

The thin-film magnetic head further includes a nonmagnetic layer 41 made of a nonmagnetic material and disposed on part of the top surface of the pole layer 24. The nonmagnetic layer 41 is made of an inorganic insulating material or a metal material, for example. Examples of the inorganic insulating material to be used for the nonmagnetic layer 41 include alumina and SiO₂. Examples of the metal material to be used for the nonmagnetic layer 41 include Ru and Ti.

The thin-film magnetic head further includes a second gap layer 27 disposed on part of the pole layer 24 and on the nonmagnetic layer 41. A portion of the top surface of the pole layer 24 apart from the medium facing surface 40 and the top surface of the connecting layer 25 are not covered with the nonmagnetic layer 41 and the second gap layer 27. The second gap layer 27 is made of a nonmagnetic material such as alumina.

The thin-film magnetic head further includes a second write shield 28 disposed on the second gap layer 27. The second write shield 28 includes: a first layer 28A disposed adjacent to the second gap layer 27; and a second layer 28B disposed on a side of the first layer 28A opposite to the second gap layer 27 and connected to the first layer 28A. The first layer 28A and the second layer 28B are made of a magnetic material. Each of the first layer 28A and the second layer 28B has an end face located in the medium facing surface 40.

The thin-film magnetic head further includes: a yoke layer 29 made of a magnetic material and disposed on a portion of the pole layer 24 away from the medium facing surface 40; a connecting layer 30 made of a conductive material and disposed on the connecting layer 25; and an insulating layer 31 made of an insulating material such as alumina and disposed around the first layer 28A, the yoke layer 29 and the connecting layer 30. The yoke layer 29 and the connecting layer 30 may be made of the same material as the first layer 28A. The first layer 28A, the yoke layer 29, the connecting layer 30 and the insulating layer 31 have flattened top surfaces.

The thin-film magnetic head further includes an insulating layer 32 made of an insulating material such as alumina and disposed on the yoke layer 29 and the insulating layer 31. The insulating layer 32 has an opening for exposing the top surface of the first layer 28A, an opening for exposing a portion of the top surface of the yoke layer 29 near an end thereof farther from the medium facing surface 40, and an opening for exposing the top surface of the connecting layer 30.

The thin-film magnetic head further includes a coil 33 made of a conductive material and disposed on the insulating layer 32. The coil 33 is planar spiral-shaped. The coil 33 includes a connecting portion 33a that is a portion near an inner end of the coil 33 and connected to the connecting portion 16a of the coil 16. The connecting portion 33a is connected to the connecting layer 30, and connected to the connecting portion 16a through the connecting layers 19, 25 and 30.

The thin-film magnetic head further includes an insulating layer 34 disposed to cover the coil 33. The insulating layer 34 is made of photoresist, for example. The second layer 28B of the second write shield 28 is disposed on the first layer 28A, the yoke layer 29 and the insulating layer 34, and connects the first layer 28A and the yoke layer 29 to each other.

The thin-film magnetic head further includes an overcoat layer 35 made of an insulating material such as alumina and disposed to cover the second layer 28B. The portion from the magnetic layer 10 to the second layer 28B constitutes a write head. The base body 211 of FIG. 24 is mainly composed of the substrate 1 and the overcoat layer 35 of FIG. 6.

As described so far, the thin-film magnetic head includes the medium facing surface 40 that faces toward the recording medium, the read head, and the write head. The read head and the write head are stacked on the substrate 1. The read head is disposed backward along the direction of travel of the recording medium (the Z direction) (in other words, disposed closer to an air-inflow end of the slider), while the write head is disposed forward along the direction of travel of the recording medium (the Z direction) (in other words, disposed closer to an air-outflow end of the slider). The thin-film magnetic head writes data on the recording medium through the use of the write head, and reads data stored on the recording medium through the use of the read head.

The read head includes: the first read shield portion 3; the second read shield portion 8; the MR stack 5 disposed between the first and second read shield portions 3 and 8 near the medium facing surface 40 in order to detect a signal magnetic field sent from the recording medium; the bias magnetic field applying layer 6; and the insulating layer 7. The bias magnetic field applying layer 6 is disposed adjacent to the rear end face of the MR stack 5, with an insulating film (not shown) provided between the MR stack 5 and the layer 6. The insulating layer 7 is disposed around the MR stack 5 and the bias magnetic field applying layer 6. The MR stack 5 is either a TMR element or a GMR element of the CPP structure. A sense current is fed to the MR stack 5 in a direction intersecting the planes of layers constituting the MR stack 5, such as the direction perpendicular to the planes of the layers constituting the MR stack 5. The resistance of the MR stack 5 changes in response to an external magnetic field, that is, a signal magnetic field sent from the recording medium. The resistance of the MR stack 5 can be determined from the sense current. It is thus possible, using the read head, to read data stored on the recording medium.

The write head includes the magnetic layer 10, the first write shield 15, the coil 16, the first gap layer 23, the pole layer 24, the nonmagnetic layer 41, the second gap layer 27, the second write shield 28, the yoke layer 29, and the coil 33. The first write shield 15 is located closer to the substrate 1 than is the second write shield 28. The pole layer 24 is located closer to the substrate 1 than is the second write shield 28.

The coils 16 and 33 generate a magnetic field that corresponds to data to be written on the recording medium. The pole layer 24 has an end face located in the medium facing surface 40, allows a magnetic flux corresponding to the magnetic field generated by the coils 16 and 33 to pass, and generates a write magnetic field used for writing the data on the recording medium by means of a perpendicular magnetic recording system.

The first write shield 15 is made of a magnetic material, and has an end face located in the medium facing surface 40 at a position backward of the end face of the pole layer 24 along the direction of travel of the recording medium (the Z direction). The first gap layer 23 is made of a nonmagnetic material, has an end face located in the medium facing surface 40, and is disposed between the first write shield 15 and the pole layer 24. In the present embodiment, the first write shield 15 includes the first layer 15A disposed on the magnetic layer 10, and the second layer 15B disposed on the first layer 15A. Part of the coil 16 is located on a side of the first layer 15A so as to pass through the space between the magnetic layer 10 and the pole layer 24.

The magnetic layer 10 has a function of returning a magnetic flux that has been generated from the end face of the pole layer 24 and has magnetized the recording medium. FIG. 6 shows an example in which the magnetic layer 10 has an end face located in the medium facing surface 40. However, since the magnetic layer 10 is connected to the first write shield 15 having an end face located in the medium facing surface 40, the magnetic layer 10 may have an end face that is closer to the medium facing surface 40 and located at a distance from the medium facing surface 40.

In the medium facing surface 40, the end face of the first write shield 15 (the end face of the second layer 15B) is located backward of the end face of the pole layer 24 along the direction of travel of the recording medium (the Z direction) (in other words, located closer to the air-inflow end of the slider) with a predetermined small distance provided therebetween by the first gap layer 23. The distance between the end face of the pole layer 24 and the end face of the first write shield 15 in the medium facing surface 40 is preferably within a range of 0.05 to 0.7 μm, or more preferably within a range of 0.1 to 0.3 μm.

The first write shield 15 takes in a magnetic flux that is generated from the end face of the pole layer 24 located in the medium facing surface 40 and that expands in directions except the direction perpendicular to the plane of the recording medium, and thereby prevents this flux from reaching the recording medium. It is thereby possible to improve the recording density.

The second write shield 28 is made of a magnetic material, and has an end face located in the medium facing surface 40 at a position forward of the end face of the pole layer 24 along the direction of travel of the recording medium (the Z direction). The second gap layer 27 is made of a nonmagnetic material, has an end face located in the medium facing surface 40, and is disposed between the second write shield 28 and the pole layer 24. In the present embodiment, the second write shield 28 includes: the first layer 28A disposed adjacent to the second gap layer 27; and the second layer 28B disposed on a side of the first layer 28A opposite to the second gap layer 27 and connected to the first layer 28A. Part of the coil 33 is disposed to pass through the space surrounded by the pole layer 24 and the second write shield 28. The second write shield 28 is connected to a portion of the yoke layer 29 away from the medium facing surface 40. The second write shield 28 is thus connected to a portion of the pole layer 24 away from the medium facing surface 40 through the yoke layer 29. The pole layer 24, the second write shield 28 and the yoke layer 29 form a magnetic path that allows a magnetic flux corresponding to the magnetic field generated by the coil 33 to pass therethrough.

In the medium facing surface 40, the end face of the second write shield 28 (the end face of the first layer 28A) is located forward of the end face of the pole layer 24 along the direction of travel of the recording medium (the Z direction) (in other words, located closer to the air-outflow end of the slider) with a predetermined small distance provided therebetween by the second gap layer 27. The distance between the end face of the pole layer 24 and the end face of the second write shield 28 in the medium facing surface 40 is preferably equal to or smaller than 200 nm, or more preferably within a range of 25 to 50 nm, so that the second write shield 28 can fully exhibit its function as a shield.

The position of the end of a bit pattern to be written on the recording medium is determined by the position of an end of the pole layer 24 closer to the second gap layer 27 in the medium facing surface 40. The second write shield 28 takes in a magnetic flux that is generated from the end face of the pole layer 24 located in the medium facing surface 40 and that expands in directions except the direction perpendicular to the plane of the recording medium, and thereby prevents this flux from reaching the recording medium. It is thereby possible to improve the recording density. Furthermore, the second write shield 28 takes in a disturbance magnetic field applied from outside the thin-film magnetic head to the thin-film magnetic head. It is thereby possible to prevent erroneous writing on the recording medium caused by the disturbance magnetic field intensively taken into the pole layer 24. The second write shield 28 also has a function of returning a magnetic flux that has been generated from the end face of the pole layer 24 and has magnetized the recording medium.

FIG. 6 shows an example in which neither the magnetic layer 10 nor the first write shield 15 is connected to the pole layer 24. However, the magnetic layer 10 may be connected to a portion of the pole layer 24 away from the medium facing surface 40. The coil 16 is not an essential component of the write head and can be dispensed with. In the example shown in FIG. 6, the yoke layer 29 is disposed on the pole layer 24, or in other words, disposed forward of the pole layer 24 along the direction of travel of the recording medium (the Z direction) (or in still other words, disposed closer to the air-outflow end of the slider). However, the yoke layer 29 may be disposed below the pole layer 24, or in other words, disposed backward of the pole layer 24 along the direction of travel of the recording medium (the Z direction) (or in still other words, disposed closer to the air-inflow end of the slider).

The heater 13 is provided for heating the components of the write head including the pole layer 24 so as to control the distance between the recording medium and the end face of the pole layer 24 located in the medium facing surface 40. Two leads that are not shown are connected to the heater 13. For example, the heater 13 is formed of a NiCr film or a layered film made up of a Ta film, a NiCu film and a Ta film. The heater 13 generates heat by being energized through the two leads, and thereby heats the components of the write head. As a result, the components of the write head expand and the end face of the pole layer 24 located in the medium facing surface 40 thereby gets closer to the recording medium.

While FIG. 6 and FIG. 7 show a write head for a perpendicular magnetic recording system, the write head of the present embodiment may be one for a longitudinal magnetic recording system.

A method of manufacturing the thin-film magnetic head of the present embodiment will now be outlined. In the method of manufacturing the thin-film magnetic head of the embodiment, first, components of a plurality of thin-film magnetic heads are formed on a single substrate (wafer) to thereby fabricate a substructure in which pre-slider portions each of which will later become a slider are aligned in a plurality of rows. Next, the substructure is cut to form a slider aggregate including a plurality of pre-slider portions aligned in a row. Next, a surface formed in the slider aggregate by cutting the substructure is lapped to thereby form the medium facing surfaces 40 of the pre-slider portions included in the slider aggregate. Next, flying rails are formed in the medium facing surfaces 40. Next, the slider aggregate is cut so as to separate the plurality of pre-slider portions from one another, whereby a plurality of sliders respectively including the thin-film magnetic heads are formed.

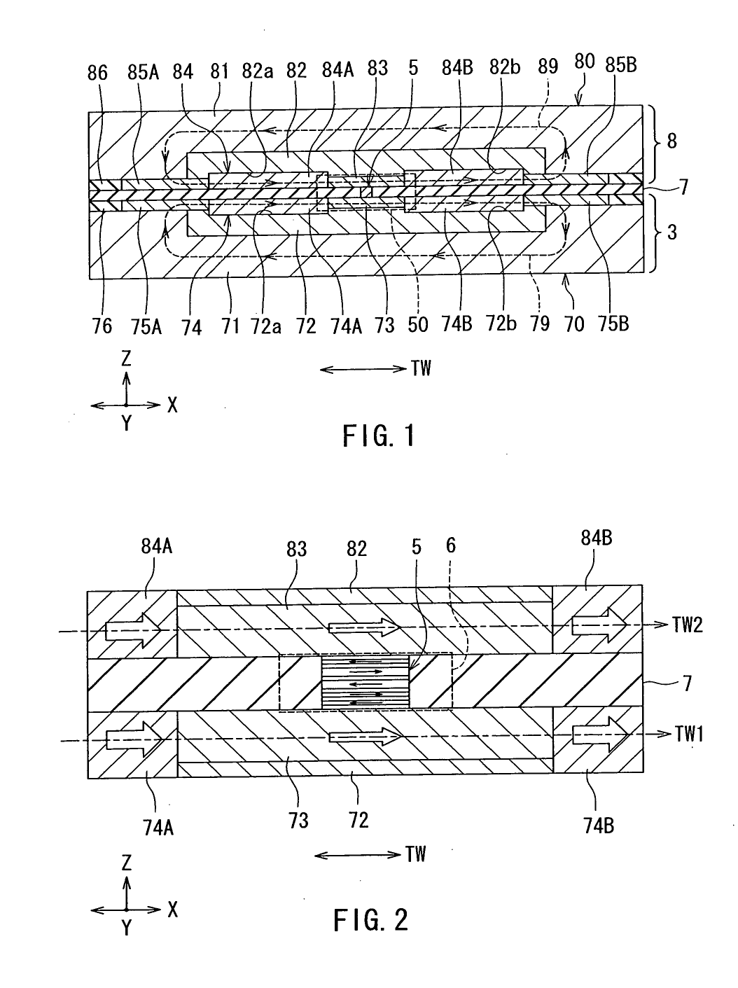

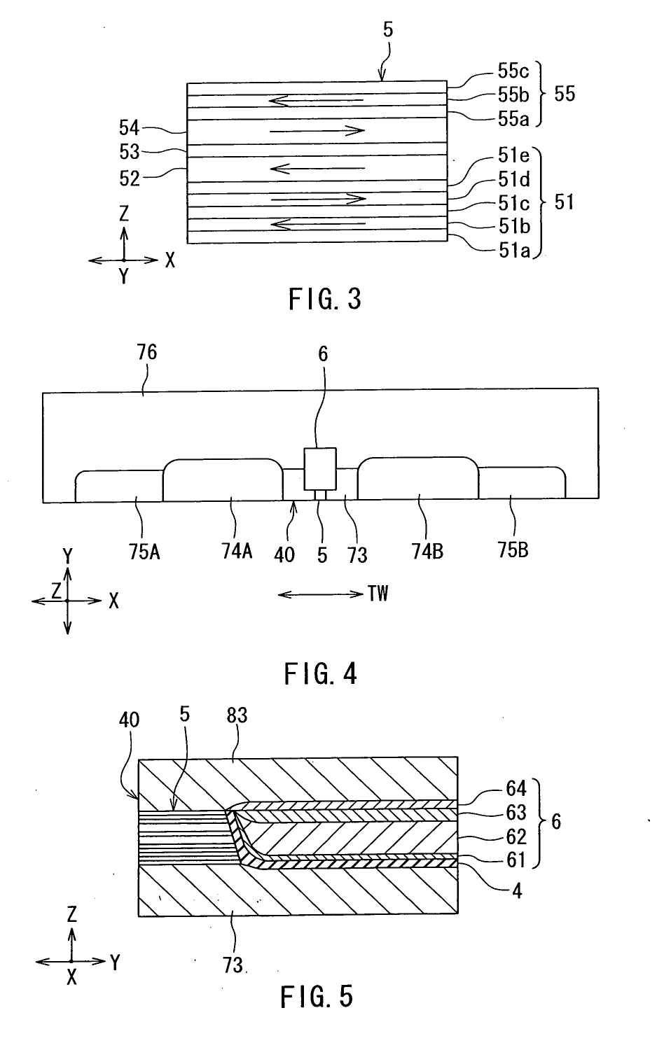

The configuration of the MR element of the present embodiment will now be described in detail with reference to FIG. 1 to FIG. 5. FIG. 1 is a cross-sectional view showing a cross section of the MR element parallel to the medium facing surface 40. FIG. 2 is an enlarged cross-sectional view of the portion 50 of FIG. 1. FIG. 3 is an enlarged cross-sectional view of the MR stack of FIG. 2. FIG. 4 is a top view of a main part of the MR element. FIG. 5 is a cross-sectional view showing a cross section of the MR element perpendicular to the medium facing surface 40 and the top surface of the substrate 1. The X, Y and Z directions shown in FIG. 24 are also shown in FIG. 1 to FIG. 5. In FIG. 1 to FIG. 3 the Y direction is orthogonal to the X and Z directions. In FIG. 4 the Z direction is orthogonal to the X and Y directions. In FIG. 5 the X direction is orthogonal to the Y and Z directions. In FIG. 1, FIG. 2 and FIG. 4 the arrow TW indicates the track width direction. The track width direction TW is the same as the X direction.

The MR element includes the first read shield portion 3, the second read shield portion 8, and the MR stack 5, the bias magnetic field applying layer 6 and the insulating layer 7 disposed between the read shield portions 3 and 8.

The first read shield portion 3 includes a first closed-magnetic-path-forming layer 71, a metal gap layer 72, a first biased shield layer 73, a first hard magnetic layer 74, coupling layers 75A and 75B, and an insulating layer 76. The first biased shield layer 73 corresponds to the first shield layer of the present invention. The first closed-magnetic-path-forming layer 71 is disposed on the insulating layer 2. A recess is formed in the top surface of the first closed-magnetic-path-forming layer 71, and the metal gap layer 72 is disposed in this recess. The first hard magnetic layer 74 includes two portions: a first portion 74A and a second portion 74B. A magnetic field produced by the two portions 74A and 74B of the first hard magnetic layer 74 is applied to the first biased shield layer 73. The top surface of the metal gap layer 72 has a first recess 72a and a second recess 72b spaced from each other. The first portion 74A is disposed on the metal gap layer 72 such that part of the first portion 74A is accommodated in the first recess 72a. The second portion 74B is disposed on the metal gap layer 72 such that part of the second portion 74B is accommodated in the second recess 72b.

The first biased shield layer 73 is disposed on the metal gap layer 72 at a location between the first recess 72a and the second recess 72b. One of opposite ends of the first biased shield layer 73 in the track width direction TW (the left end in FIG. 1) touches the first portion 74A. The other of the opposite ends of the first biased shield layer 73 in the track width direction TW (the right end in FIG. 1) touches the second portion 74B. The coupling layer 75A is disposed on the first closed-magnetic-path-forming layer 71 and the metal gap layer 72 at such a location that the first portion 74A is sandwiched between the coupling layer 75A and the first biased shield layer 73. The coupling layer 75B is disposed on the first closed-magnetic-path-forming layer 71 and the metal gap layer 72 at such a location that the second portion 74B is sandwiched between the coupling layer 75B and the first biased shield layer 73. The insulating layer 76 is disposed around the first biased shield layer 73, the first hard magnetic layer 74 and the coupling layers 75A and 75B.

Each of the first closed-magnetic-path-forming layer 71, the first biased shield layer 73 and the coupling layers 75A and 75B is formed of a soft magnetic material such as NiFe, CoFe, CoFeB, CoFeNi or FeN. Each of the first closed-magnetic-path-forming layer 71 and the first biased shield layer 73 functions as a shield for the MR stack 5. The metal gap layer 72 is formed of a nonmagnetic metal material such as Ru. The first hard magnetic layer 74 is formed mainly of a hard magnetic material (permanent magnet material) such as CoPt or CoCrPt. The insulating layer 76 is formed of an insulating material such as alumina.

The first biased shield layer 73 and the two portions 74A and 74B of the first hard magnetic layer 74 are aligned in a first direction parallel to the track width direction TW. In FIG. 2 the first direction is shown with a dashed arrow TW1. The two portions 74A and 74B of the first hard magnetic layer 74 have magnetizations in the same direction parallel to the first direction TW1. Thick arrows in the portions 74A and 74B in FIG. 2 show the direction of the magnetizations of the portions 74A and 74B. The magnetic field produced by the two portions 74A and 74B of the first hard magnetic layer 74 brings the first biased shield layer 73 into a single magnetic domain state so that the magnetization of the first biased shield layer 73 is directed parallel to the first direction TW1. In FIG. 2 a thick arrow in the first biased shield layer 73 shows the direction of the magnetization of the first biased shield layer 73. In this way, the direction of the magnetization of the first biased shield layer 73 is set by the first hard magnetic layer 74.

The coupling layer 75A is connected to an end of the first portion 74A of the first hard magnetic layer 74, the end being located farther from the first biased shield layer 73. The coupling layer 75B is connected to an end of the second portion 74B of the first hard magnetic layer 74, the end being located farther from the first biased shield layer 73. The first closed-magnetic-path-forming layer 71 is connected to the coupling layers 75A and 75B. The first closed-magnetic-path-forming layer 71 is separated from the first biased shield layer 73 by the metal gap layer 72. The coupling layers 75A and 75B and the first closed-magnetic-path-forming layer 71 magnetically connect the respective ends of the two portions 74A and 74B of the first hard magnetic layer 74, the ends being located farther from the first biased shield layer 73, and form a first closed magnetic path 79 shown in FIG. 1, together with the first biased shield layer 73 and the two portions 74A and 74B of the first hard magnetic layer 74. The coupling layers 75A and 75B and the first closed-magnetic-path-forming layer 71 constitute a first closed-magnetic-path-forming portion 70.

The second read shield portion 8 includes a second closed-magnetic-path-forming layer 81, a metal gap layer 82, a second biased shield layer 83, a second hard magnetic layer 84, coupling layers 85A and 85B, and an insulating layer 86. The second biased shield layer 83 corresponds to the second shield layer of the present invention. The second biased shield layer 83 is disposed such that the MR stack 5 and the insulating layer 7 are sandwiched between the second biased shield layer 83 and the first biased shield layer 73. The second hard magnetic layer 84 includes two portions: a first portion 84A and a second portion 84B. A magnetic field produced by the two portions 84A and 84B of the second hard magnetic layer 84 is applied to the second biased shield layer 83. The first portion 84A is disposed such that the insulating layer 7 is sandwiched between the first portion 84A and the first portion 74A of the first hard magnetic layer 74. The second portion 84B is disposed such that the insulating layer 7 is sandwiched between the second portion 84B and the second portion 74B of the first hard magnetic layer 74.

One of opposite ends of the second biased shield layer 83 in the track width direction TW (the left end in FIG. 1) touches the first portion 84A. The other of the opposite ends of the second biased shield layer 83 in the track width direction TW (the right end in FIG. 1) touches the second portion 84B. The coupling layer 85A is disposed on the insulating layer 7 at such a location that the first portion 84A is sandwiched between the coupling layer 85A and the second biased shield layer 83. The coupling layer 85B is disposed on the insulating layer 7 at such a location that the second portion 84B is sandwiched between the coupling layer 85B and the second biased shield layer 83. The insulating layer 86 is disposed around the second biased shield layer 83, the second hard magnetic layer 84 and the coupling layers 85A and 85B.

The metal gap layer 82 is disposed to cover the second biased shield layer 83 and the second hard magnetic layer 84. The bottom surface of the metal gap layer 82 has a first recess 82a and a second recess 82b spaced from each other. The first portion 84A is disposed below the metal gap layer 82 such that part of the first portion 84A is accommodated in the first recess 82a. The second portion 84B is disposed below the metal gap layer 82 such that part of the second portion 84B is accommodated in the second recess 82b. The second closed-magnetic-path-forming layer 81 is disposed to cover the metal gap layer 82. A recess is formed in the bottom surface of the second closed-magnetic-path-forming layer 81, and the metal gap layer 82 is disposed in this recess.

Each of the second closed-magnetic-path-forming layer 81, the second biased shield layer 83 and the coupling layers 85A and 85B is formed of a soft magnetic material such as NiFe, CoFe, CoFeB, CoFeNi or FeN. Each of the second closed-magnetic-path-forming layer 81 and the second biased shield layer 83 functions as a shield for the MR stack 5. The metal gap layer 82 is formed of a nonmagnetic metal material such as Ru. The second hard magnetic layer 84 is formed mainly of a hard magnetic material (permanent magnet material) such as CoPt or CoCrPt. The insulating layer 86 is formed of an insulating material such as alumina.

The second biased shield layer 83 and the two portions 84A and 84B of the second hard magnetic layer 84 are aligned in a second direction parallel to the track width direction TW. In FIG. 2 the second direction is shown with a dashed arrow TW2. The two portions 84A and 84B of the second hard magnetic layer 84 have magnetizations in the same direction parallel to the second direction TW2. Thick arrows in the portions 84A and 84B in FIG. 2 show the direction of the magnetizations of the portions 84A and 84B. The magnetic field produced by the two portions 84A and 84B of the second hard magnetic layer 84 brings the second biased shield layer 83 into a single magnetic domain state so that the magnetization of the second biased shield layer 83 is directed parallel to the second direction TW2. In FIG. 2 a thick arrow in the second biased shield layer 83 shows the direction of the magnetization of the second biased shield layer 83. In this way, the direction of the magnetization of the second biased shield layer 83 is set by the second hard magnetic layer 84. In the present embodiment, the magnetization direction of the first biased shield layer 73 and the magnetization direction of the second biased shield layer 83 are the same.

The coupling layer 85A is connected to an end of the first portion 84A of the second hard magnetic layer 84, the end being located farther from the second biased shield layer 83. The coupling layer 85B is connected to an end of the second portion 84B of the second hard magnetic layer 84, the end being located farther from the second biased shield layer 83. The second closed-magnetic-path-forming layer 81 is connected to the coupling layers 85A and 85B. The second closed-magnetic-path-forming layer 81 is separated from the second biased shield layer 83 by the metal gap layer 82. The coupling layers 85A and 85B and the second closed-magnetic-path-forming layer 81 magnetically connect the respective ends of the two portions 84A and 84B of the second hard magnetic layer 84, the ends being located farther from the second biased shield layer 83, and form a second closed magnetic path 89 shown in FIG. 1, together with the second biased shield layer 83 and the two portions 84A and 84B of the second hard magnetic layer 84. The coupling layers 85A and 85B and the second closed-magnetic-path-forming layer 81 constitute a second closed-magnetic-path-forming portion 80.

As shown in FIG. 3, the MR stack 5 includes a first ferromagnetic layer 52, a second ferromagnetic layer 54, and a spacer layer 53 made of a nonmagnetic material and disposed between the ferromagnetic layers 52 and 54. The MR stack 5 further includes a first coupling layer 51 disposed between the first biased shield layer 73 and the first ferromagnetic layer 52, and a second coupling layer 55 disposed between the second ferromagnetic layer 54 and the second biased shield layer 83.

The first ferromagnetic layer 52 is magnetically coupled to the first biased shield layer 73. The second ferromagnetic layer 54 is magnetically coupled to the second biased shield layer 83. The first ferromagnetic layer 52 and the second ferromagnetic layer 52 have magnetizations that are in directions antiparallel to each other when any external magnetic field other than a magnetic field resulting from the first and second hard magnetic layers 74 and 84 is not applied to the first and second ferromagnetic layers 52 and 54, and that change their directions in response to an external magnetic field other than the magnetic field resulting from the first and second hard magnetic layers 74 and 84. Thus, each of the ferromagnetic layers 52 and 54 functions as a free layer. Each of the ferromagnetic layers 52 and 54 is formed of a ferromagnetic material having a low coercivity, such as NiFe, CoFe, CoFeB, CoFeNi, or FeN.

When there is no magnetic field applied to the MR element from outside the MR element, any magnetic field applied to the ferromagnetic layers 52 and 54, other than the bias magnetic field generated by the bias magnetic field applying layer 6, results from the hard magnetic layers 74 and 84. Therefore, the state in which any external magnetic field other than a magnetic field resulting from the first and second hard magnetic layers 74 and 84 is not applied to the first and second ferromagnetic layers 52 and 54 is a state in which any bias magnetic field generated by the bias magnetic field applying layer 6 is not applied to the ferromagnetic layers 52 and 54 when there is no magnetic field applied to the MR element from outside the MR element.

In the case where the MR stack 5 is a TMR element, the spacer layer 53 is a tunnel barrier layer. The spacer layer 53 in this case is formed of an insulating material such as alumina, SiO₂, or MgO. In the case where the MR stack 5 is a GMR element of the CPP structure, the spacer layer 53 is a nonmagnetic conductive layer. The spacer layer 53 in this case is formed of, for example, a nonmagnetic conductive material such as Ru, Rh, Ir, Re, Cr, Zr or Cu, or an oxide semiconductor material such as ZnO, In₂O₃, or SnO₂.

The first coupling layer 51 is a layer for magnetically coupling the first biased shield layer 73 and the first ferromagnetic layer 52 to each other. The first coupling layer 51 also serves to adjust the distance between the first biased shield layer 73 and the first ferromagnetic layer 52. The first coupling layer 51 includes a nonmagnetic conductive layer 51a, a magnetic layer 51b, a nonmagnetic conductive layer 51c, a magnetic layer 51d and a nonmagnetic conductive layer 51e that are stacked in this order on the first biased shield layer 73. The nonmagnetic conductive layer 51e touches the bottom surface of the spacer layer 53. The nonmagnetic conductive layers 51a, 51c and 51e are each formed of a nonmagnetic conductive material containing at least one of Ru, Rh, Ir, Cr, Cu, Ag, Au, Pt and Pd, for example. The magnetic layers 51b and 51d are each formed of a magnetic material such as NiFe, CoFe, CoFeB, CoFeNi or FeN.

The first biased shield layer 73 and the magnetic layer 51b are antiferromagnetically coupled to each other by the RKKY interaction through the nonmagnetic conductive layer 51a. The magnetizations of the first biased shield layer 73 and the magnetic layer 51b are therefore directed antiparallel to each other. The magnetic layer 51b and the magnetic layer 51d are antiferromagnetically coupled to each other by the RKKY interaction through the nonmagnetic conductive layer 51c. The magnetizations of the magnetic layer 51b and the magnetic layer 51d are therefore directed antiparallel to each other. The magnetic layer 51d and the first ferromagnetic layer 52 are antiferromagnetically coupled to each other by the RKKY interaction through the nonmagnetic conductive layer 51e. The magnetizations of the magnetic layer 51d and the first ferromagnetic layer 52 are therefore directed antiparallel to each other. As a result, the magnetizations of the first ferromagnetic layer 52 and the first biased shield layer 73 are directed antiparallel to each other.

The second coupling layer 55 is a layer for magnetically coupling the second biased shield layer 83 and the second ferromagnetic layer 54 to each other. The second coupling layer 55 also serves to adjust the distance between the second biased shield layer 83 and the second ferromagnetic layer 54. The second coupling layer 55 includes a nonmagnetic conductive layer 55a, a magnetic layer 55b, and a nonmagnetic conductive layer 55c that are stacked in this order on the second ferromagnetic layer 54. The nonmagnetic conductive layer 55c touches the bottom surface of the second biased shield layer 83. The nonmagnetic conductive layers 55a and 55c are each formed of a nonmagnetic conductive material containing at least one of Ru, Rh, Ir, Cr, Cu, Ag, Au, Pt and Pd, for example. The magnetic layer 55b is formed of a magnetic material such as NiFe, CoFe, CoFeB, CoFeNi or FeN.

The second biased shield layer 83 and the magnetic layer 55b are antiferromagnetically coupled to each other by the RKKY interaction through the nonmagnetic conductive layer 55c. The magnetizations of the second biased shield layer 83 and the magnetic layer 55b are therefore directed antiparallel to each other. The magnetic layer 55b and the second ferromagnetic layer 54 are antiferromagnetically coupled to each other by the RKKY interaction through the nonmagnetic conductive layer 55a. The magnetizations of the magnetic layer 55b and the second ferromagnetic layer 54 are therefore directed antiparallel to each other. As a result, the magnetizations of the second ferromagnetic layer 54 and the second biased shield layer 83 are in the same direction.

Thus, in the present embodiment, the coupling between the first biased shield layer 73 and the first ferromagnetic layer 52 is such coupling that the magnetizations of the first biased shield layer 73 and the first ferromagnetic layer 52 are in directions antiparallel to each other, and the coupling between the second biased shield layer 83 and the second ferromagnetic layer 54 is such coupling that the magnetizations of the second biased shield layer 83 and the second ferromagnetic layer 54 are in the same direction. In the present embodiment, since the magnetizations of the first biased shield layer 73 and the second biased shield layer 83 are in the same direction, the directions of the magnetizations of the first ferromagnetic layer 52 and the second ferromagnetic layer 54 are antiparallel to each other.

The coupling layers 51 and 55 may be interchanged so that the coupling between the first biased shield layer 73 and the first ferromagnetic layer 52 will be such coupling that the magnetizations of the first biased shield layer 73 and the first ferromagnetic layer 52 are in the same direction while the coupling between the second biased shield layer 83 and the second ferromagnetic layer 54 will be such coupling that the magnetizations of the second biased shield layer 83 and the second ferromagnetic layer 54 are in directions antiparallel to each other.

The configuration of the coupling layer that directs the magnetizations of two coupled layers antiparallel to each other is not limited to a five-layer configuration like that of the coupling layer 51 shown in FIG. 3. For example, the coupling layer may be composed of five or a greater odd number of nonmagnetic conductive layers, and magnetic layers disposed between every adjacent nonmagnetic conductive layers, or may be composed of a single nonmagnetic conductive layer. The configuration of the coupling layer that directs the magnetizations of two coupled layers to the same direction is not limited to a three-layer configuration like that of the coupling layer 55 shown in FIG. 3. For example, the coupling layer may be composed of four or a greater even number of nonmagnetic conductive layers, and magnetic layers disposed between every adjacent nonmagnetic conductive layers.

As shown in FIG. 5, an insulating film 4 made of an insulating material such as alumina is disposed between the bias magnetic field applying layer 6 and each of the rear end face of the MR stack 5 and the top surface of the first biased shield layer 73. The bias magnetic field applying layer 6 includes a buffer layer 61, a ferromagnetic layer 62, an antiferromagnetic layer 63 and a protection layer 64 that are stacked in this order on the insulating film 4. The buffer layer 61 and the protection layer 64 are each formed of a nonmagnetic conductive material such as Ta. The ferromagnetic layer 62 is formed of a ferromagnetic material such as CoFe. The antiferromagnetic layer 63 is formed of an antiferromagnetic material such as IrMn. The ferromagnetic layer 62 corresponds to the third ferromagnetic layer of the present invention.

The ferromagnetic layer 62 is exchange-coupled to the antiferromagnetic layer 63 and thereby has a magnetization fixed to the direction perpendicular to the medium facing surface 40. By means of the fixed magnetization of the ferromagnetic layer 62, the bias magnetic field applying layer 6 applies a bias magnetic field to the ferromagnetic layers 52 and 54 so that the magnetizations of the ferromagnetic layers 52 and 54 change their directions compared with a state in which no bias magnetic field is applied to the ferromagnetic layers 52 and 54. The bias magnetic field applying layer 6 preferably applies a bias magnetic field to the ferromagnetic layers 52 and 54 so that the magnetizations of the ferromagnetic layers 52 and 54 are directed orthogonal to each other.

The MR element of the present embodiment is of the CPP structure. More specifically, a sense current, which is a current used for detecting a signal magnetic field, is fed in a direction intersecting the planes of the layers constituting the MR stack 5, such as the direction perpendicular to the planes of the layers constituting the MR stack 5. The sense current is fed to the MR stack 5 through the first closed-magnetic-path-forming layer 71, the metal gap layer 72 and the first biased shield layer 73 of the first read shield portion 3, and the second closed-magnetic-path-forming layer 81, the metal gap layer 82 and the second biased shield layer 83 of the second read shield portion 8.

An example of specific configuration of the MR element of the present embodiment will now be described. In the following description, thickness of each layer is a dimension taken in the direction of stacking of a plurality of layers in a portion where the layers are stacked. In this example, each of the first and second closed-magnetic-path-forming layers 71 and 81 is made of NiFe and has a thickness of 1.0 μm. Each of the first biased shield layer 73, the second biased shield layer 83 and the coupling layers 75A, 75B, 85A and 85B is made of NiFe and has a thickness of 30 nm. Each of the metal gap layers 72 and 82 is made of Ru. The portion of the metal gap layer 72 sandwiched between the first closed-magnetic-path-forming layer 71 and the first biased shield layer 73 and the portion of the metal gap layer 82 sandwiched between the second closed-magnetic-path-forming layer 81 and the second biased shield layer 83 each have a thickness of 50 nm.

In this example, the first and second portions 74A and 74B of the first hard magnetic layer 74 and the first and second portions 84A and 84B of the second hard magnetic layer 84 each have a configuration shown in Table 1 below. The vertical relationship among the layers in Table 1 corresponds to the vertical relationship among the actual layers.

TABLE 1

| Configuration of hard | |
|---|---|
| magnetic layers 74, 84 | Thickness (nm) |
| Cr layer | 10 |
| CoPt layer | 25 |
| Cr layer | 5 |
| CoPt layer | 25 |
| Cr layer | 10 |

As shown in Table 1, in this example, the first and second portions 74A and 74B of the first hard magnetic layer 74 and the first and second portions 84A and 84B of the second hard magnetic layer 84 each have a configuration in which Cr layers and CoPt layers made of CoPt (a hard magnetic material) are alternately stacked. Each Cr layer serves as an underlayer for forming a CoPt layer thereon. In this example, in the two portions 74A and 74B of the first hard magnetic layer 74 and the two portions 84A and 84B of the second hard magnetic layer 84, the thickness of the portion made of a hard magnetic material is the total of the thicknesses of the two CoPt layers, i.e., 50 nm.

In this example, the distance between the first portion 74A and the second portion 74B and the distance between the first portion 84A and the second portion 84B taken in the track width direction are each 0.5 μm.

Table 2 below shows a specific example of configuration of the MR stack 5 of FIG. 3. In this example, each of the first ferromagnetic layer 52 and the second ferromagnetic layer 54 is composed of a stack of three magnetic layers. In this example, the spacer layer 53 is made of MgO. Therefore, the spacer layer 53 is a tunnel barrier layer and the MR stack 5 is a TMR element. The dimension of the MR stack 5 taken in the track width direction is 50 nm, and the dimension of the MR stack 5 taken in the direction perpendicular to the medium facing surface 40 is 60 nm. The insulating layer 7 is made of alumina and has a thickness of 18 nm, which is nearly equal to the thickness of the MR stack 5.

TABLE 2

| Configuration of MR stack 5 | | Material | Thickness (nm) |
|---|---|---|---|
| Second coupling | Nonmagnetic conductive | Ru | 0.8 |
| layer 55 | layer 55c | | |
| | Magnetic layer 55b | CoFe | 1.0 |
| | Nonmagnetic conductive | Ru | 0.8 |
| | layer 55a | | |
| Second | Magnetic layer | CoFe | 1.5 |
| ferromagnetic | Magnetic layer | CoFeB | 2.0 |
| layer 54 | Magnetic layer | CoFe | 1.5 |
| Spacer layer 53 | | MgO | 1.0 |
| First | Magnetic layer | CoFe | 1.5 |
| ferromagnetic | Magnetic layer. | CoFeB | 2.0 |
| layer 52 | Magnetic layer | CoFe | 1.5 |
| First coupling | Nonmagnetic conductive | Ru | 0.8 |
| layer 51 | layer 51e | | |
| | Magnetic layer 51d | CoFe | 1.0 |
| | Nonmagnetic conductive | Ru | 0.8 |
| | layer 51c | | |
| | Magnetic layer 51b | CoFe | 1.0 |
| | Nonmagnetic conductive | Ru | 0.8 |
| | layer 51a | | |

Table 3 below shows a specific example of configuration of the bias magnetic field applying layer 6 of FIG. 5. CoFe used to form the ferromagnetic layer 62 preferably contains 50 to 70 atomic % of Co and a balance of Fe.

TABLE 3

| Configuration of bias magnetic | | |
|---|---|---|
| field applying layer 6 | Material | Thickness (nm) |
| Protection layer 64 | Ta | 2 |
| Antiferromagnetic layer 63 | IrMn | 7 |
| Ferromagnetic layer 62 | CoFe | 20 |
| Buffer layer 61 | Ta | 1 |

The dimension of the bias magnetic field applying layer 6 taken in the track width direction is 0.3 μm, and the dimension of the bias magnetic field applying layer 6 taken in the direction perpendicular to the medium facing surface 40 is 1.0 μm. In this example, as shown in FIG. 2, the dimension of the bias magnetic field applying layer 6 taken in the track width direction is greater than the dimension of the MR stack 5 taken in the track width direction, and is smaller than the distance between the first portion 74A and the second portion 74B and the distance between the first portion 84A and the second portion 84B taken in the track width direction. As a result, it is possible to apply a bias magnetic field generated by the bias magnetic field applying layer 6 intensively to the MR stack 5 while preventing the bias magnetic field from affecting the function of the hard magnetic layers 74 and 84.

By forming the bias magnetic field applying layer 6 to have such a shape that the dimension thereof taken in the direction perpendicular to the medium facing surface 40 is greater than the dimension thereof taken in the track width direction, it is possible to stabilize the magnetization of the bias magnetic field applying layer 6 by the effect of the shape anisotropy, and consequently, it is possible to stabilize the bias magnetic field.

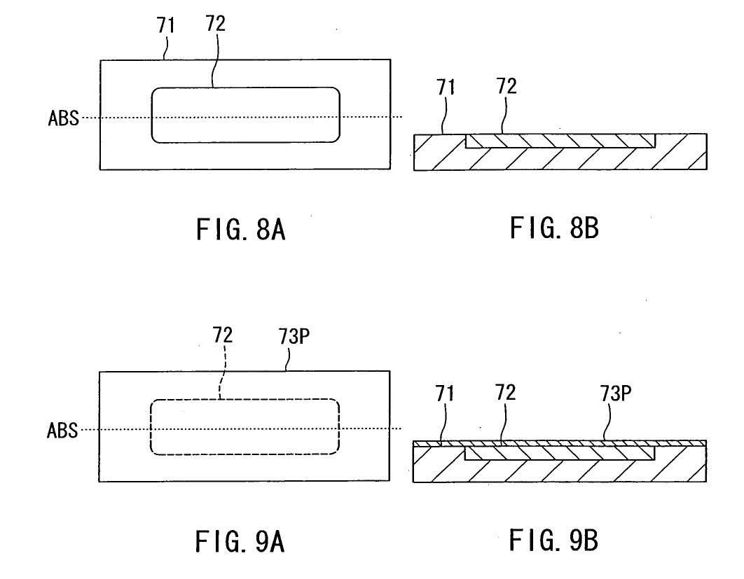

Reference is now made to FIG. 8A to FIG. 17B to describe a method of manufacturing the MR element of the present embodiment. FIG. 8A and FIG. 8B show a step of the method of manufacturing the MR element. FIG. 8A is a top view of a stack of layers formed in the course of manufacturing the MR element. FIG. 8B shows a cross section of the stack of layers taken at the position indicated with the dotted line ABS in FIG. 8A. In FIG. 8A and the other figures, the dotted line ABS indicates the position at which the medium facing surface 40 is to be formed.

In the step shown in FIG. 8A and FIG. 8B, first, the first closed-magnetic-path-forming layer 71 having a predetermined pattern is formed on the insulating layer 2 by, for example, frame plating. Next, a mask (not shown) is formed on the first closed-magnetic-path-forming layer 71, the mask having an opening at a position where the metal gap layer 72 is to be formed later. The mask is formed by patterning a photoresist layer by photolithography. Next, the first closed-magnetic-path-forming layer 71 is selectively etched using the mask by, for example, ion milling, to thereby form the recess in the top surface of the first closed-magnetic-path-forming layer 71. With the mask left unremoved, the metal gap layer 72 is then formed by, for example, sputtering, so as to be disposed in the recess of the top surface of the first closed-magnetic-path-forming layer 71. Next, the mask is lifted off.

FIG. 9A and FIG. 9B show the next step. FIG. 9A is a top view of a stack of layers formed in the course of manufacturing the MR element. FIG. 9B shows a cross section of the stack of layers taken at the position indicated with the dotted line ABS in FIG. 9A. In this step, a magnetic layer 73P that is to become the first biased shield layer 73 and the coupling layers 75A and 75B later is formed on the first closed-magnetic-path-forming layer 71 and the metal gap layer 72 by, for example, sputtering.

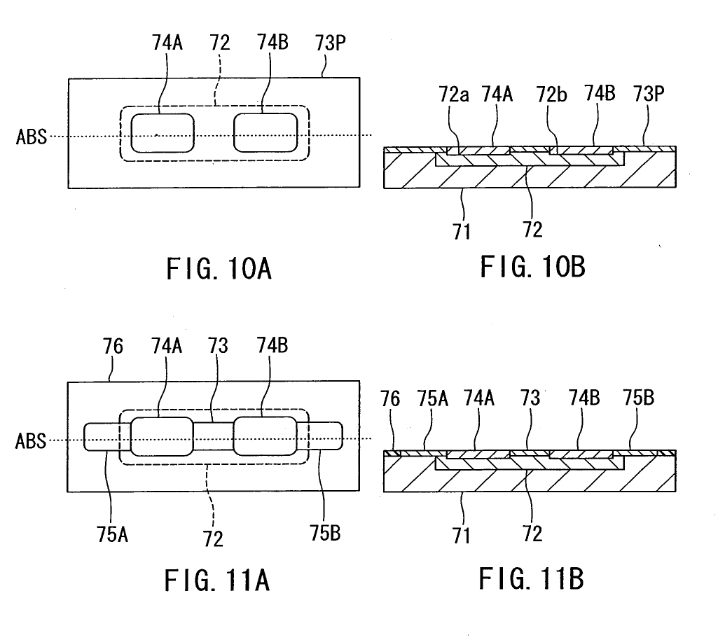

FIG. 10A and FIG. 10B show the next step. FIG. 10A is a top view of a stack of layers formed in the course of manufacturing the MR element. FIG. 10B shows a cross section of the stack of layers taken at the position indicated with the dotted line ABS in FIG. 10A. In this step, first, a mask (not shown) is formed on the magnetic layer 73P, the mask having openings at positions where the first portion 74A and the second portion 74B of the first hard magnetic layer 74 are to be formed later. The mask is formed by patterning a photoresist layer by photolithography. Next, using the mask, the magnetic layer 73P and the metal gap layer 72 are selectively etched by, for example, ion milling, so that two openings are formed in the magnetic layer 73P and the first recess 72a and the second recess 72b contiguous to the two openings of the magnetic layer 73P are formed in the metal gap layer 72. Next, with the mask left unremoved, the first portion 74A of the first hard magnetic layer 74 is formed to be disposed in one of the two openings and the first recess 72a contiguous thereto, and the second portion 74B of the first hard magnetic layer 74 is formed to be disposed in the other of the two openings and the second recess 72b contiguous thereto, both of the first and second portions 74A and 74B being formed by, for example, sputtering. Next, the mask is lifted off.

FIG. 11A and FIG. 11B show the next step. FIG. 11A is a top view of a stack of layers formed in the course of manufacturing the MR element. FIG. 11B shows a cross section of the stack of layers taken at the position indicated with the dotted line ABS in FIG. 11A. In this step, first, a mask (not shown) is formed on the top surface of the stack of layers shown in FIG. 10A and FIG. 10B, the mask covering the first and second portions 74A and 74B of the first hard magnetic layer 74 and portions of the magnetic layer 73P that are to become the first biased shield layer 73 and the coupling layers 75A and 75B later. The mask is formed by patterning a photoresist layer by photolithography. Next, the magnetic layer 73P is selectively etched using the mask by, for example, ion milling, to thereby form the first biased shield layer 73 and the coupling layers 75A and 75B. With the mask left unremoved, the insulating layer 76 is then formed by, for example, sputtering, so as to be disposed around the first biased shield layer 73, the first hard magnetic layer 74 and the coupling layers 75A and 75B. The top surfaces of the first biased shield layer 73, the first hard magnetic layer 74, the coupling layers 75A and 75B and the insulating layer 76 are thereby flattened. Next, the mask is lifted off.

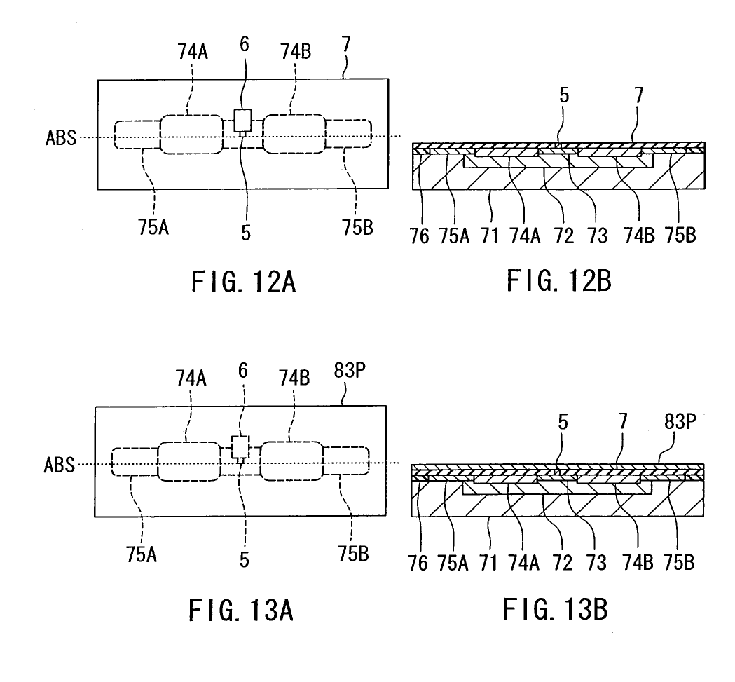

FIG. 12A and FIG. 12B show the next step. FIG. 12A is a top view of a stack of layers formed in the course of manufacturing the MR element. FIG. 12B shows a cross section of the stack of layers taken at the position indicated with the dotted line ABS in FIG. 12A. In this step, first, on the top surface of the stack of layers shown in FIG. 11A and FIG. 11B a plurality of films to later become the layers constituting the MR stack 5 are formed one by one to thereby form a multilayer film for the MR stack 5. Next, on the multilayer film for the MR stack 5 a mask (not shown) is formed to cover a portion of the multilayer film to become the MR stack 5. Next, the multilayer film for the MR stack 5 is selectively etched using the mask by, for example, ion milling, to thereby form the MR stack 5. Next, with the mask left unremoved, the insulating film 4 is formed and furthermore, a multilayer film to later become the bias magnetic field applying layer 6 is formed by, for example, sputtering. Next, the mask is lifted off.

Next, a mask (not shown) is formed to cover the MR stack 5 and a portion to become the bias magnetic field applying layer 6 of the above-mentioned multilayer film. Next, the multilayer film to become the bias magnetic field applying layer 6 is selectively etched using the mask by, for example, ion milling, to thereby form the bias magnetic field applying layer 6. With the mask left unremoved, the insulating layer 7 is then formed by, for example, sputtering. Next, the mask is lifted off.

FIG. 13A and FIG. 13B show the next step. FIG. 13A is a top view of a stack of layers formed in the course of manufacturing the MR element. FIG. 13B shows a cross section of the stack of layers taken at the position indicated with the dotted line ABS in FIG. 13A. In this step, a magnetic layer 83P to later become the second biased shield layer 83 and the coupling layers 85A and 85B is formed on the top surface of the stack of layers shown in FIG. 12A and FIG. 12B.

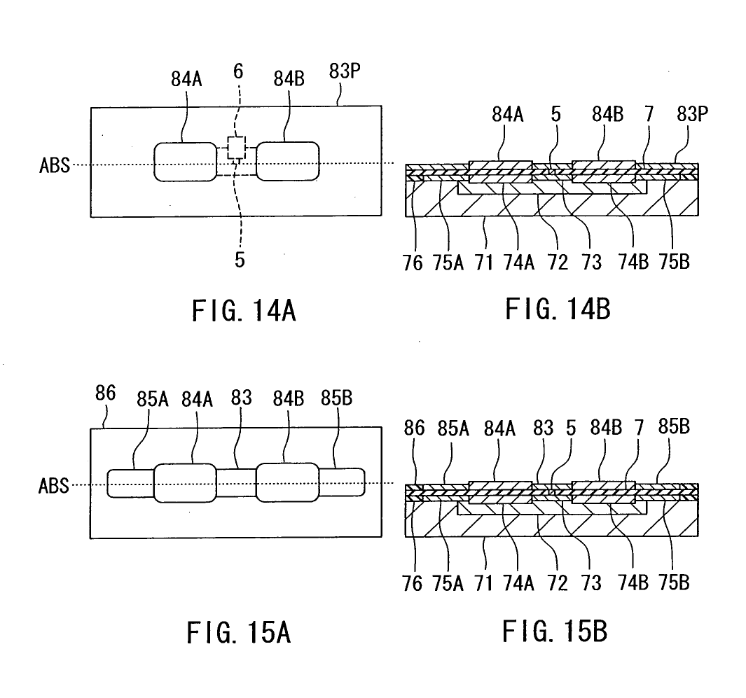

FIG. 14A and FIG. 14B show the next step. FIG. 14A is a top view of a stack of layers formed in the course of manufacturing the MR element. FIG. 14B shows a cross section of the stack of layers taken at the position indicated with the dotted line ABS in FIG. 14A. In this step, first, a mask (not shown) is formed on the magnetic layer 83P, the mask having openings at positions where the first portion 84A and the second portion 84B of the second hard magnetic layer 84 are to be formed later. The mask is formed by patterning a photoresist layer by photolithography. Next, two openings are formed in the magnetic layer 83P by selectively etching the magnetic layer 83P using the mask by, for example, ion milling. Next, with the mask left unremoved, the first portion 84A of the second hard magnetic layer 84 is formed such that a part thereof is disposed in one of the two openings and the second portion 84B of the second hard magnetic layer 84 is formed such that a part thereof is disposed in the other of the two openings, both of the first and second portions 84A and 84B being formed by, for example, sputtering. Next, the mask is lifted off.

FIG. 15A and FIG. 15B show the next step. FIG. 15A is a top view of a stack of layers formed in the course of manufacturing the MR element. FIG. 15B shows a cross section of the stack of layers taken at the position indicated with the dotted line ABS in FIG. 15A. In this step, first, a mask (not shown) is formed on the top surface of the stack of layers shown in FIG. 14A and FIG. 14B, the mask covering the first and second portions 84A and 84B of the second hard magnetic layer 84 and portions of the magnetic layer 83P that are to become the second biased shield layer 83 and the coupling layers 85A and 85B later. The mask is formed by patterning a photoresist layer by photolithography. Next, the magnetic layer 83P is selectively etched using the mask by, for example, ion milling, to thereby form the second biased shield layer 83 and the coupling layers 85A and 85B. With the mask left unremoved, the insulating layer 86 is then formed by, for example, sputtering, so as to be disposed around the second biased shield layer 83, the second hard magnetic layer 84 and the coupling layers 85A and 85B. Next, the mask is lifted off.

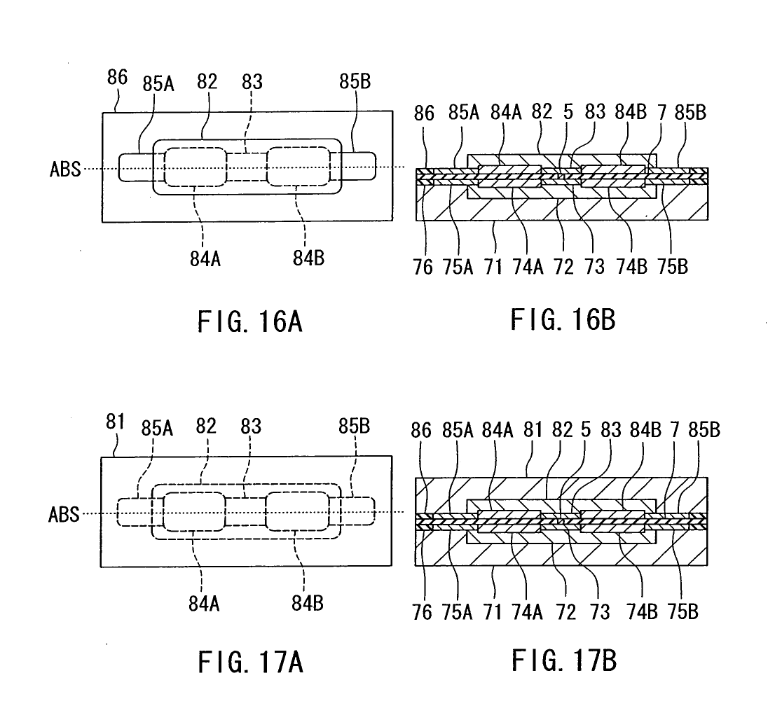

FIG. 16A and FIG. 16B show the next step. FIG. 16A is a top view of a stack of layers formed in the course of manufacturing the MR element. FIG. 16B shows a cross section of the stack of layers taken at the position indicated with the dotted line ABS in FIG. 16A. In this step, first, a mask (not shown) is formed on the top surface of the stack of layers shown in FIG. 15A and FIG. 15B, the mask having openings at a position where the metal gap layer 82 is to be formed later. The mask is formed by patterning a photoresist layer by photolithography. Next, the metal gap layer 82 is selectively formed using the mask by, for example, sputtering, to cover the second biased shield layer 83 and the second hard magnetic layer 84. Next, the mask is lifted off.

FIG. 17A and FIG. 17B show the next step. FIG. 17A is a top view of a stack of layers formed in the course of manufacturing the MR element. FIG. 17B shows a cross section of the stack of layers taken at the position indicated with the dotted line ABS in FIG. 17A. In this step, the second closed-magnetic-path-forming layer 81 is formed by, for example, frame plating, to cover the metal gap layer 82.

The magnetization directions of the hard magnetic layers 74 and 84 are set by magnetizing. The magnetization direction of the bias magnetic field applying layer 6 is set by annealing in a magnetic field, and determined by the direction of the magnetic field at that time. The magnetization directions of the hard magnetic layers 74 and 84 set by magnetizing will not change by the annealing in the magnetic field performed for setting the magnetization direction of the bias magnetic field applying layer 6.

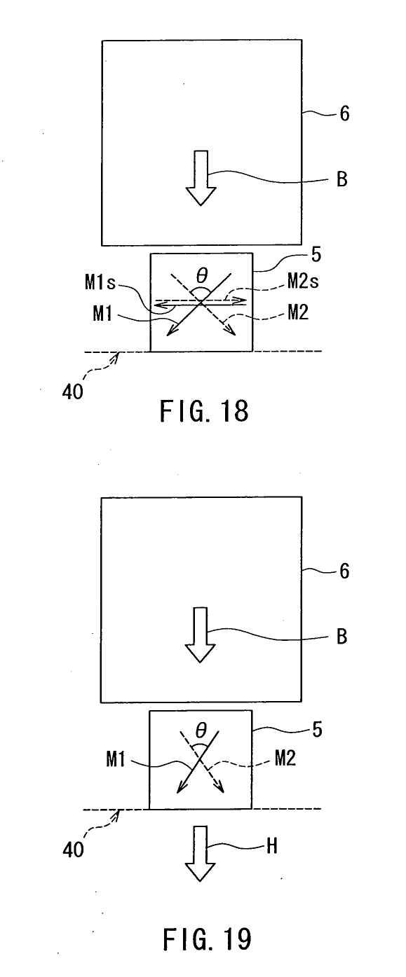

The operation of the MR element of the present embodiment will now be described with reference to FIG. 18 to FIG. 20. Each of FIG. 18 to FIG. 20 shows the MR stack 5 and the bias magnetic field applying layer 6. In FIG. 18 to FIG. 20 the arrow marked with “B” indicates a bias magnetic field generated by the bias magnetic field applying layer 6. The arrow marked with “M1s” indicates the direction of the magnetization of the first ferromagnetic layer 52 when any external magnetic field (including a bias magnetic field) other than a magnetic field resulting from the hard magnetic layers 74 and 84 is not applied to the first ferromagnetic layer 52. The arrow marked with “M2s” indicates the direction of the magnetization of the second ferromagnetic layer 54 when any external magnetic field described above is not applied to the second ferromagnetic layer 54. The arrow marked with “M1” indicates the direction of the magnetization of the first ferromagnetic layer 52 when a bias magnetic field B is applied to the first ferromagnetic layer 52. The arrow marked with “M2” indicates the direction of the magnetization of the second ferromagnetic layer 54 when the bias magnetic field B is applied to the second ferromagnetic layer 54.

As shown in FIG. 18, when no external magnetic field is applied to the ferromagnetic layers 52 and 54, the directions of the magnetizations of the ferromagnetic layers 52 and 54 are antiparallel to each other. When the bias magnetic field B is applied but no signal magnetic field is applied to the ferromagnetic layers 52 and 54, the directions of the magnetizations of the ferromagnetic layers 52 and 54 become non-antiparallel to each other. When in this state, it is desirable that the direction of the magnetization of the first ferromagnetic layer 52 and the direction of the magnetization of the second ferromagnetic layer 54 each form an angle of 45 degrees with respect to the medium facing surface 40 and the relative angle θ between the directions of the magnetizations of the ferromagnetic layers 52 and 54 be 90 degrees.

FIG. 19 shows a state in which the bias magnetic field B and also a signal magnetic field H in the same direction as the bias magnetic field B are applied to the ferromagnetic layers 52 and 54. When in this state, the angle formed by the direction of the magnetization of the first ferromagnetic layer 52 with respect to the medium facing surface 40 and the angle formed by the direction of the magnetization of the second ferromagnetic layer 54 with respect to the medium facing surface 40 are each greater compared with the state shown in FIG. 18. As a result, the relative angle θ between the directions of the magnetizations of the ferromagnetic layers 52 and 54 is smaller compared with the state shown in FIG. 18.

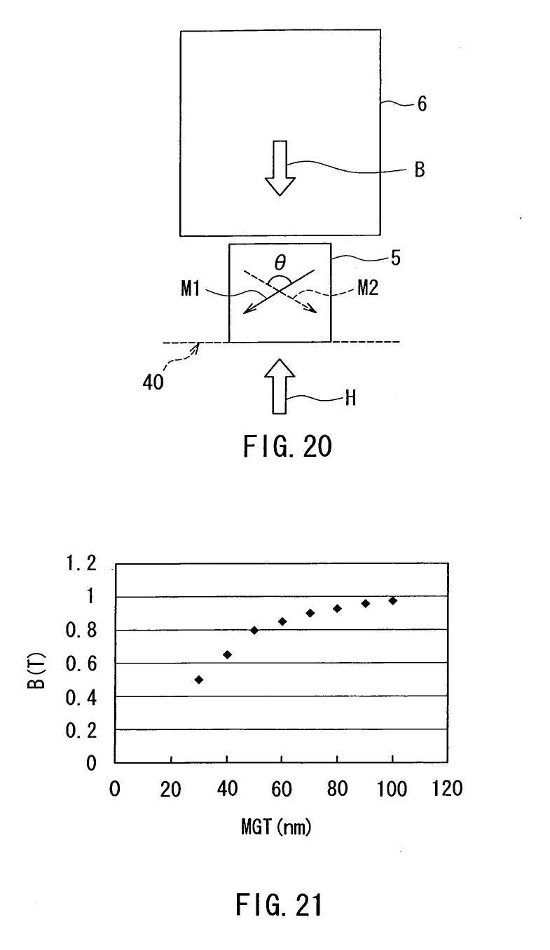

FIG. 20 shows a state in which the bias magnetic field B and also a signal magnetic field H in a direction opposite to the direction of the bias magnetic field B are applied to the ferromagnetic layers 52 and 54. When in this state, the angle formed by the direction of the magnetization of the first ferromagnetic layer 52 with respect to the medium facing surface 40 and the angle formed by the direction of the magnetization of the second ferromagnetic layer 54 with respect to the medium facing surface 40 are each smaller compared with the state shown in FIG. 18. As a result, the relative angle θ between the directions of the magnetizations of the ferromagnetic layers 52 and 54 is greater compared with the state shown in FIG. 18.

The relative angle between the directions of the magnetizations of the ferromagnetic layers 52 and 54 thus changes in response to a signal magnetic field, and as a result, the resistance of the MR stack 5 changes. It is therefore possible to detect the signal magnetic field by detecting the resistance of the MR stack 5. The resistance of the MR stack 5 can be determined from the potential difference produced in the MR stack 5 when a sense current is fed to the MR stack 5. It is thus possible, through the use of the MR element, to read data stored on the recording medium.

The effects of the MR element of the present embodiment will now be described. In the MR element of the present embodiment, the magnetization direction of the first biased shield layer 73 is set by the first hard magnetic layer 74, the magnetization direction of the second biased shield layer 83 is set by the second hard magnetic layer 84, the first ferromagnetic layer 52 is magnetically coupled to the first biased shield layer 73, and the second ferromagnetic layer 54 is magnetically coupled to the second biased shield layer 83. The magnetizations of the two ferromagnetic layers 52 and 54 are thereby directed antiparallel to each other when any external magnetic field other than a magnetic field resulting from the first and second hard magnetic layers 74 and 84 is not applied to the two ferromagnetic layers 52 and 54. According to the present embodiment, it is thus possible to direct the magnetizations of the two ferromagnetic layers 52 and 54 antiparallel to each other when no external magnetic field is applied, without making use of antiferromagnetic coupling between the two ferromagnetic layers through the spacer layer 53. Consequently, according to the present embodiment, no limitation is imposed on the material and thickness of the spacer layer 53, in contrast to the case of making use of antiferromagnetic coupling between the two ferromagnetic layers.

Furthermore, the present embodiment allows a reduction in read gap length because no antiferromagnetic layer is present between the MR stack 5 and each of the biased shield layers 73 and 83.

Furthermore, according to the present embodiment, the first hard magnetic layer 74 includes the first and second portions 74A and 74B disposed on two sides of the first biased shield layer 73, the two sides being opposite to each other in the direction orthogonal to the direction in which the layers constituting the MR stack 5 are stacked, and the second hard magnetic layer 84 includes the first and second portions 84A and 84B disposed on two sides of the second biased shield layer 83, the two sides being opposite to each other in the direction orthogonal to the direction in which the layers constituting the MR stack 5 are stacked. In addition, the MR element of the present embodiment includes: the first closed-magnetic-path-forming portion 70 (the coupling layers 75A and 75B and the first closed-magnetic-path-forming layer 71) that magnetically couples the respective ends of the two portions 74A and 74B of the first hard magnetic layer 74, the ends being located farther from the first biased shield layer 73, and forms the first closed magnetic path 79 together with the first biased shield layer 73 and the two portions 74A and 74B of the first hard magnetic layer 74; and the second closed-magnetic-path-forming portion 80 (the coupling layers 85A and 85B and the second closed-magnetic-path-forming layer 81) that magnetically couples the respective ends of the two portions 84A and 84B of the second hard magnetic layer 84, the ends being located farther from the second biased shield layer 83, and forms the second closed magnetic path 89 together with the second biased shield layer 83 and the two portions 84A and 84B of the second hard magnetic layer 84. This makes it possible that the magnetization directions of the first and second biased shield layers 73 and 83 are efficiently set by the first and second hard magnetic layers 74 and 84 without generation of any unwanted leakage magnetic field.

The first closed-magnetic-path-forming layer 71 is separated from the first biased shield layer 73 by the metal gap layer 72, and the second closed-magnetic-path-forming layer 81 is separated from the second biased shield layer 83 by the metal gap layer 82. If the metal gap layer 72 is too thin, part of the magnetic field generated by the first hard magnetic layer 74 gets into the first closed-magnetic-path-forming layer 71 via the metal gap layer 72, and consequently the magnetic field generated by the first hard magnetic layer 74 cannot be fully applied to the first biased shield layer 73. Similarly, if the metal gap layer 82 is too thin, part of the magnetic field generated by the second hard magnetic layer 84 gets into the second closed-magnetic-path-forming layer 81 via the metal gap layer 82, and consequently the magnetic field generated by the second hard magnetic layer 84 cannot be fully applied to the second biased shield layer 83. In this connection, in order to determine an appropriate thickness of each of the metal gap layers 72 and 82, a simulation was performed to study the relationship between the thickness of each of the metal gap layers 72 and 82 and the flux density (corresponding to magnetization) of each of the first and second biased shield layers 73 and 83.

The model of the MR element used in the simulation had the same configuration as the example of specific configuration of the MR element described previously, except the thickness of each of the metal gap layers 72 and 82. The thickness of each of the metal gap layers 72 and 82 was varied by 10-nm increments from 30 nm to 100 nm. Here, the thickness of the metal gap layer 72 specifically refers to the thickness of the portion of the metal gap layer 72 sandwiched between the first closed-magnetic-path-forming layer 71 and the first biased shield layer 73, and the thickness of the metal gap layer 82 specifically refers to the thickness of the portion of the metal gap layer 82 sandwiched between the second closed-magnetic-path-forming layer 81 and the second biased shield layer 83.

FIG. 21 shows the relationship between the thickness MGT (nm) of each of the metal gap layers 72 and 82 and the flux density B (T) of each of the first and second biased shield layers 73 and 83 obtained by simulation. As shown in FIG. 21, the flux density B increases as the thickness MGT increases. A higher flux density B is preferred from the viewpoint of controlling the magnetizations of the ferromagnetic layers 52 and 54 of the MR stack 5 by using the magnetizations of the first and second biased shield layers 73 and 83. However, the first and second biased shield layers 73 and 83 cannot fully perform the shield function if their magnetizations are close to the saturation magnetization. From this viewpoint, a lower flux density B is preferred. Here, by way of example, the value of flux density B that can satisfy the demands for the flux density B from both of the above two viewpoints is defined as 0.8 T, and the thickness MGT is set to 50 nm on the basis of the relationship shown in FIG. 21.

A description will now be made on the results of first to third experiments in which characteristics were compared between the MR element of the present embodiment and MR elements of Comparative Examples.

### [First Experiment]

For the first experiment, fabricated was an MR element of Example in which the thickness of each of the metal gap layers 72 and 82 was set to 50 nm and the other conditions were the same as the model of the MR element used in the simulation described above. In this MR element of Example, the flux density of each of the first and second biased shield layers 73 and 83 is 0.8 T.

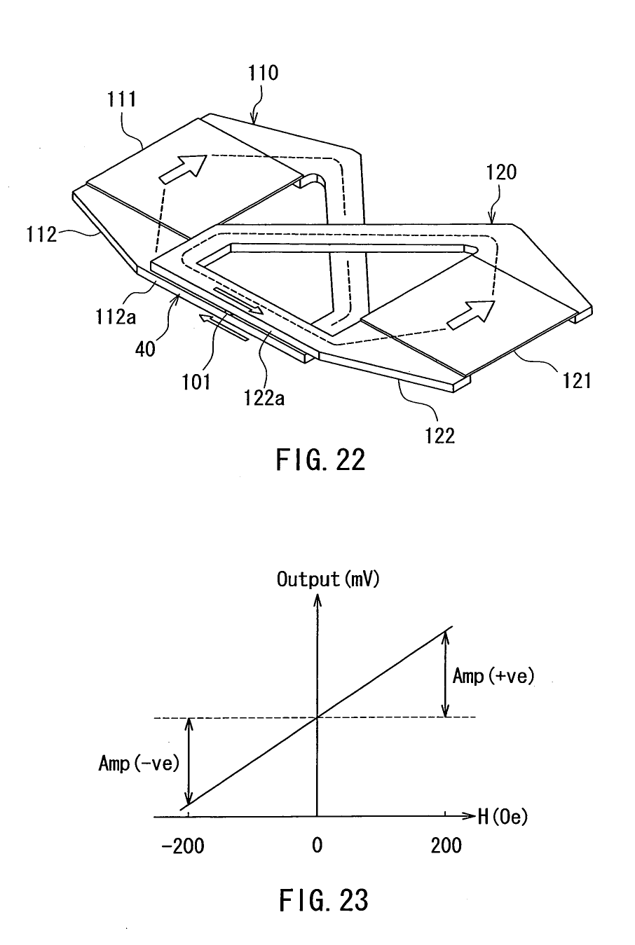

For the first experiment, also fabricated was an MR element of First Comparative Example having the configuration shown in FIG. 22. As shown in FIG. 22, the MR element of First Comparative Example has an MR stack 101, a first shield 110 disposed on the lower side of the MR stack 101, and a second shield 120 disposed on the upper side of the MR stack 101.

The first shield 110 has a hard magnetic layer 111 and a shield layer 112. The hard magnetic layer 111 is, as seen from the medium facing surface 40, located to the left of the MR stack 101 and away from the medium facing surface 40. The shield layer 112 couples one end of the hard magnetic layer 111 closer to the medium facing surface 40 to the opposite end. The entire shape of the first shield 110 made up of a combination of the hard magnetic layer 111 and the shield layer 112 is a loop shape, and the first shield 110 thus forms a closed magnetic path. The shield layer 112 includes a single magnetic domain portion 112a that has a side portion located at the medium facing surface 40 and extending in the track width direction.

The second shield 120 has a hard magnetic layer 121 and a shield layer 122. The hard magnetic layer 121 is, as seen from the medium facing surface 40, located to the right of the MR stack 101 and away from the medium facing surface 40. The shield layer 122 couples one end of the hard magnetic layer 121 closer to the medium facing surface 40 to the opposite end. The entire shape of the first shield 120 made up of a combination of the hard magnetic layer 121 and the shield layer 122 is a loop shape, and the second shield 120 thus forms a closed magnetic path. The shield layer 122 includes a single magnetic domain portion 122a that has a side portion located at the medium facing surface 40 and extending in the track width direction.

The hard magnetic layers 111 and 121 are magnetized so that their magnetizations are in the same direction perpendicular to the medium facing surface 40. The single magnetic domain portions 112a and 122a are bought into a single magnetic domain state so that the magnetization directions thereof are each parallel to the track width direction and are antiparallel to each other. Thick arrows in FIG. 22 show the magnetization directions. The MR stack 101 is sandwiched between the single magnetic domain portions 112a and 122a. The MR stack 101 has a configuration without the nonmagnetic conductive layer 51a and the magnetic layer 51b out of the MR stack 5 of FIG. 3. Consequently, the magnetizations of the ferromagnetic layers 52 and 54 are directed antiparallel to each other.

The shield layers 112 and 122 are each made of NiFe and each have a thickness of 0.7 μm. The dimension of each of the single magnetic domain portions 112a and 122a taken in the direction perpendicular to the medium facing surface 40 is 5 μm. The single magnetic domain portions 112a and 122a each have a flux density of 0.8 T.

In the first experiment, electromagnetic transducing characteristics of the MR elements of Example and First Comparative Example were evaluated. Electromagnetic transducing characteristics are characteristics of an MR element exhibited when the MR element detects a signal magnetic field sent from a recording medium while a thin-film magnetic head including the MR element is made to fly over the surface of the recording medium through the use of a head gimbal assembly described later. One of the electromagnetic transducing characteristics is read output. Here, the waveform of an output voltage of an MR element obtained when a signal magnetic field having any amplitude and changing polarity from positive to negative and vice versa is applied to the MR element is referred to as a read output waveform, and the read, output is defined as the difference between the maximum value and the minimum value, or the peak-to-peak value, of an isolated waveform of the read output waveform. The MR elements of Example and First Comparative Example both had a maximum read output of 15 mV. Therefore, the MR elements of Example and First Comparative Example are equivalent in terms of read output.

### [Second Experiment]

In the second experiment, read output and asymmetry of the read output waveform were measured for each of the MR elements of Example and First Comparative Example. Asymmetry of the read output waveform refers to asymmetry of two portions of the read output waveform of an MR element when a signal magnetic field having any amplitude and changing polarity from positive to negative and vice versa is applied to the MR element, the two portions corresponding to the positive and negative polarities of the signal magnetic field. Reference is now made to FIG. 23 to describe the method of measurement of the asymmetry of the read output waveform of the MR element employed in the second experiment. In FIG. 23 the horizontal axis represents the applied magnetic field H to the MR element, and the vertical axis represents the output voltage of the MR element. In the second experiment, as shown in FIG. 23, the difference (absolute value) between the output voltage of the MR element when the applied magnetic field was +200 Oe (1 Oe=79.6 A/m) and the output voltage of the MR element when the applied magnetic field was zero was defined as Amp(+ve). In addition, the difference (absolute value) between the output voltage of the MR element when the applied magnetic field was −200 Oe and the output voltage of the MR element when the applied magnetic field was zero was defined as Amp(−ve). Then, the asymmetry of the read output waveform of the MR element was defined by the following expression.

{Amp(+ve)−Amp (−ve)}/{Amp(+ve)+Amp(−ve)}

In the second experiment, the read output obtained when applying a signal magnetic field having an amplitude of 200 Oe and changing polarity from positive to negative and vice versa, and the standard deviation of the asymmetry, which represents variations in asymmetry, were also determined for each of the MR elements of Example and First Comparative Example. The results are shown in Table 4 below.

TABLE 4

| | Read output | Standard deviation of |
|---|---|---|
| | (mV) | asymmetry (%) |
| 1st Comparative Example | 5 | 20 |
| Example | 5 | 10 |

The results shown in Table 4 indicate that the MR element of Example is capable of reducing variations in asymmetry while providing an equivalent read output, compared with the MR element of First Comparative Example. Presumably, the reason why the MR element of Example is smaller in variations in asymmetry is that the magnetization directions of the first and second biased shield layers 73 and 83 are stable when an external magnetic field is applied. To be more specific, the shield layers 112 and 122 of the MR element of First Comparative Example are susceptible to changes in their magnetic domain structures when an external magnetic field is applied, because the entire shield layers 112 and 122 are not brought into a single magnetic domain state. In contrast, in the MR element of Example, the first and second portions 74A and 74B of the first hard magnetic layer 74 having a high coercivity are disposed on opposite sides of the first biased shield layer 73 in the track width direction, and similarly the first and second portions 84A and 84B of the second hard magnetic layer 84 having a high coercivity are disposed on opposite sides of the second biased shield layer 83 in the track width direction, so that the entire first and second biased shield layers 73 and 83 are brought into a single magnetic domain state. Consequently, the magnetic domain structures of the first and second biased shield layers 73 and 84 of the MR element of Example will not easily change when an external magnetic field is applied.

### [Third Experiment]

The third experiment will now be described. In the third experiment, the read output and the asymmetry of the read output waveform were measured for each of the MR element of Example and an MR element of Second Comparative Example. The MR element of Second Comparative Example has the same configuration as that of the MR element of Example except that the dimension of the bias magnetic field applying layer 6 taken in the track width direction is 1.0 μm in the MR element of Second Comparative Example. In the MR element of Second Comparative Example the dimension of the bias magnetic field applying layer 6 taken in the track width direction is greater than the distance between the first and second portions 74A and 74B taken in the track width direction and the distance between the first and second portions 84A and 84B taken in the track width direction, each of these distances being 0.5 μm.

The read output obtained when applying a signal magnetic field having an amplitude of 200 Oe and changing polarity from positive to negative and vice versa, and the standard deviation of the asymmetry, which represents variations in asymmetry, were determined for each of the MR elements of Example and Second Comparative Example. The results are shown in Table 5 below.

TABLE 5

| | Read output | Standard deviation of |
|---|---|---|
| | (mV) | asymmetry (%) |
| 2nd Comparative Example | 5 | 14 |
| Example | 5 | 10 |

The results shown in Table 4 indicate that the MR element of Example is capable of reducing variations in asymmetry while providing an equivalent read output, compared with the MR element of Second Comparative Example. In the MR element of Second Comparative Example, since the dimension of the bias magnetic field applying layer 6 taken in the track width direction is greater than the distance between the first and second portions 74A and 74B taken in the track width direction and the distance between the first and second portions 84A and 84B taken in the track width direction, the bias magnetic field generated by the bias magnetic field applying layer 6 presumably weakens the functions of the hard magnetic layers 74 and 84. In addition, in the MR element of Second Comparative Example, since the dimension of the bias magnetic field applying layer 6 taken in the track width direction is equal to the dimension thereof taken in the direction perpendicular to the medium facing surface 40, it is not possible to obtain the effect of shape anisotropy of the bias magnetic field applying layer 6 that stabilizes the magnetization of the bias magnetic field applying layer 6. Presumably, these factors have caused greater variations in asymmetry in the MR element of Second Comparative Example than in the MR element of Example.

According to the present embodiment, the feature of setting the magnetization directions of the first and second biased shield layers 73 and 83 by using the first and second hard magnetic layers 74 and 84 makes it possible to provide an MR element that has a configuration in which the ferromagnetic layers 52 and 54 are magnetically coupled to the biased shield layers 73 and 83 and that operates in a stable manner when an external magnetic field is applied, as can be seen from the results of the second and third experiments.

A head assembly and a magnetic disk drive of the present embodiment will now be described. Reference is now made to FIG. 25 to describe the head assembly of the present embodiment. The head assembly of the present embodiment includes the slider 210 shown in FIG. 24 and a supporter that flexibly supports the slider 210. Forms of this head assembly include a head gimbal assembly and a head arm assembly described below.

The head gimbal assembly 220 will be first described. The head gimbal assembly 220 has the slider 210 and a suspension 221 as the supporter that flexibly supports the slider 210. The suspension 221 has: a plate-spring-shaped load beam 222 formed of stainless steel, for example; a flexure 223 to which the slider 210 is joined, the flexure 223 being located at an end of the load beam 222 and giving an appropriate degree of freedom to the slider 210; and a base plate 224 located at the other end of the load beam 222. The base plate 224 is attached to an arm 230 of an actuator for moving the slider 210 along the x direction across the tracks of a magnetic disk platter 262. The actuator has the arm 230 and a voice coil motor that drives the arm 230. A gimbal section for maintaining the orientation of the slider 210 is provided in the portion of the flexure 223 on which the slider 210 is mounted.

The head gimbal assembly 220 is attached to the arm 230 of the actuator. An assembly including the arm 230 and the head gimbal assembly 220 attached to the arm 230 is called a head arm assembly. An assembly including a carriage having a plurality of arms with a plurality of head gimbal assemblies 220 respectively attached to the arms is called a head stack assembly.

FIG. 25 shows the head arm assembly of the present embodiment. In this head arm assembly, the head gimbal assembly 220 is attached to an end of the arm 230. A coil 231 that is part of the voice coil motor is fixed to the other end of the arm 230. A bearing 233 is provided in the middle of the arm 230. The bearing 233 is attached to a shaft 234 that rotatably supports the arm 230.

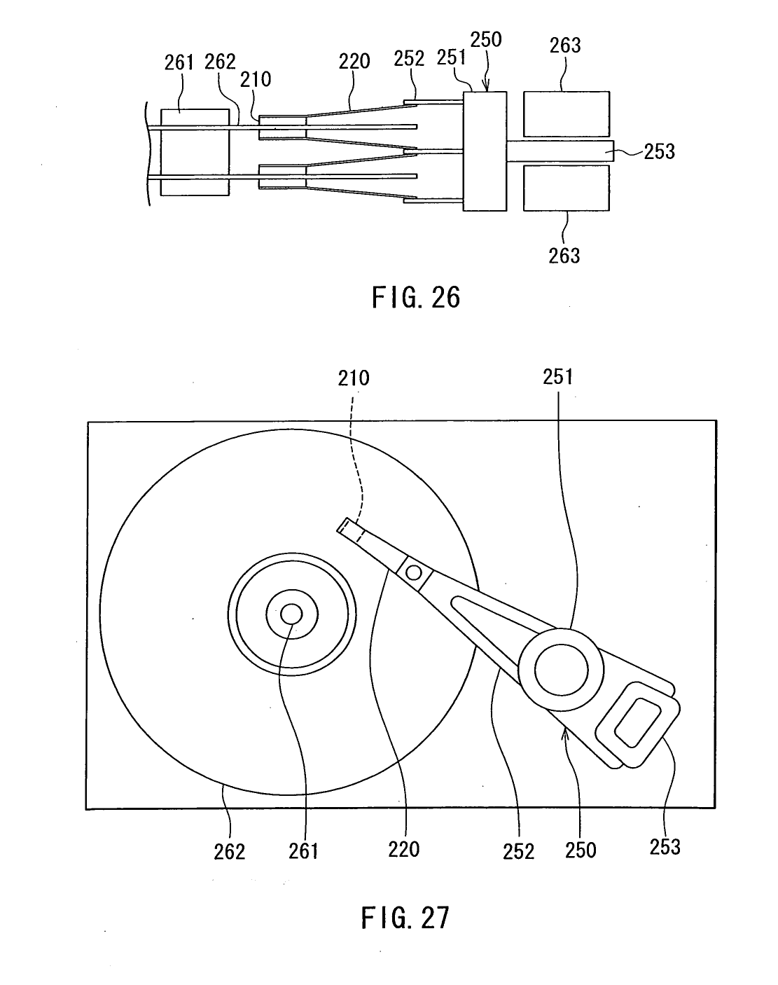

Reference is now made to FIG. 26 and FIG. 27 to describe an example of the head stack assembly and the magnetic disk drive of the present embodiment. FIG. 26 is an illustrative view showing a main part of the magnetic disk drive, and FIG. 27 is a top view of the magnetic disk drive. The head stack assembly 250 includes a carriage 251 having a plurality of arms 252. A plurality of head gimbal assemblies 220 are attached to the arms 252 such that the assemblies 220 are aligned in the vertical direction with spacing between every adjacent ones. A coil 253 that is part of the voice coil motor is mounted on a side of the carriage 251 opposite to the arms 252. The head stack assembly 250 is installed in the magnetic disk drive. The magnetic disk drive includes a plurality of magnetic disk platters 262 mounted on a spindle motor 261. Two of the sliders 210 are allocated to each of the platters 262 such that the two sliders 210 are opposed to each other with a platter 262 disposed in between. The voice coil motor includes permanent magnets 263 disposed to be opposed to each other, the coil 253 of the head stack assembly 250 being placed between the magnets 263. The actuator and the head stack assembly 250 except the sliders 210 support the sliders 210 and align them with respect to the magnetic disk platters 262.

In the magnetic disk drive of the present embodiment, the actuator moves the slider 210 across the tracks of the magnetic disk platter 262 and aligns the slider 210 with respect to the magnetic disk platter 262. The thin-film magnetic head included in the slider 210 writes data on the magnetic disk platter 262 by using the write head, and reads data stored on the magnetic disk platter 262 by using the read head.

The head assembly and the magnetic disk drive of the present embodiment exhibit effects similar to those of the thin-film magnetic head of the embodiment described previously.

The present invention is not limited to the foregoing embodiment but can be carried out in various modifications. For example, each of the coupling layers 51 and 55 may include two magnetic layers and a nonmagnetic conductive layer disposed between the two magnetic layers, and the nonmagnetic conductive layer of one of the coupling layers may have such a thickness that the two magnetic layers are antiferromagnetically coupled to each other while the nonmagnetic conductive layer of the other of the coupling layers may have such a thickness that the two magnetic layers are ferromagnetically coupled to each other.

In addition, the first hard magnetic layer 74 and the second hard magnetic layer 84 may be made to have greatly different coercivities and the first and second hard magnetic layers 74 and 84 may be magnetized so that their magnetization directions are antiparallel to each other. In this case, the magnetization directions of the first biased shield layer 73 and the second biased shield layer 83 are also antiparallel to each other. Therefore, in this case, it is possible to direct the magnetizations of the ferromagnetic layers 52 and 54 antiparallel to each other by forming the coupling layers 51 and 55 to have the same configuration and function.

In addition, the bias magnetic field applying layer 6 may be formed of a hard magnetic layer having a coercivity greatly different from that of each of the hard magnetic layers 74 and 84, and the bias magnetic field applying layer 6 may be magnetized so that its magnetization direction is orthogonal to the magnetization directions of the hard magnetic layers 74 and 84.

While the present embodiment has shown an example in which the spacer layer is a tunnel barrier layer, the spacer layer of the present invention may be a nonmagnetic conductive layer, or may be a spacer layer of the current-confined-path type that includes a portion allowing the, passage of currents and a portion intercepting the passage of currents.

While the present embodiment has been described with reference to a thin-film magnetic head having a structure in which the read head is formed on the base body and the write head is stacked on the read head, the read head and the write head may be stacked in the reverse order. If the thin-film magnetic head is to be used only for read operations, the magnetic head may be configured to include the read head only.

The present invention is applicable not only to MR elements used as read heads of thin-film magnetic heads, but also to MR elements used for various purposes in general.

It is apparent that the present invention can be carried out in various forms and modifications in the light of the foregoing descriptions. Accordingly, within the scope of the following claims and equivalents thereof, the present invention can be carried out in forms other than the foregoing most preferable embodiments.

What is claimed is:

1. A magnetoresistive element comprising:
a first shield layer and a second shield layer;
an MR stack disposed between the first and second shield layers;
a first hard magnetic layer for setting a magnetization direction of the first shield layer; and
a second hard magnetic layer for setting a magnetization direction of the second shield layer,
the MR stack including a first ferromagnetic layer magnetically coupled to the first shield layer, a second ferromagnetic layer magnetically coupled to the second shield layer, and a spacer layer made of a nonmagnetic material and disposed between the first and second ferromagnetic layers, wherein the first and second ferromagnetic layers have magnetizations that are in directions antiparallel to each other when any external magnetic field other than a magnetic field resulting from the first and second hard magnetic layers is not applied to the first and second ferromagnetic layers, and that change their directions in response to an external magnetic field other than the magnetic field resulting from the first and second hard magnetic layers.

2. The magnetoresistive element according to claim 1, wherein:
the first hard magnetic layer includes two portions disposed on two sides of the first shield layer, the two sides being opposite to each other in a direction orthogonal to a direction in which the layers constituting the MR stack are stacked, the first shield layer and the two portions of the first hard magnetic layer are aligned in a first direction, and the two portions of the first hard magnetic layer have magnetizations in the same direction parallel to the first direction; and
the second hard magnetic layer includes two portions disposed on two sides of the second shield layer, the two sides being opposite to each other in the direction orthogonal to the direction in which the layers constituting the MR stack are stacked, the second shield layer and the two portions of the second hard magnetic layer are aligned in a second direction, and the two portions of the second hard magnetic layer have magnetizations in the same direction parallel to the second direction.

3. The magnetoresistive element according to claim 2, further comprising: a first closed-magnetic-path-forming portion that magnetically couples respective ends of the two portions of the first hard magnetic layer, the ends being located farther from the first shield layer, and forms a first closed magnetic path together with the first shield layer and the two portions of the first hard magnetic layer; and a second closed-magnetic-path-forming portion that magnetically couples respective ends of the two portions of the second hard magnetic layer, the ends being located farther from the second shield layer, and forms a second closed magnetic path together with the second shield layer and the two portions of the second hard magnetic layer.

4. The magnetoresistive element according to claim 1, wherein the magnetization direction of the first shield layer and the magnetization direction of the second shield layer are the same, and one of the coupling between the first shield layer and the first ferromagnetic layer and the coupling between the second shield layer and the second ferromagnetic layer is such coupling that the magnetizations of the two coupled layers are in the same direction, while the other is such coupling that the magnetizations of the two coupled layers are in directions antiparallel to each other.

5. The magnetoresistive element according to claim 4, further comprising: a first coupling layer disposed between the first shield layer and the first ferromagnetic layer and magnetically coupling the first shield layer and the first ferromagnetic layer to each other; and a second coupling layer disposed between the second shield layer and the second ferromagnetic layer and magnetically coupling the second shield layer and the second ferromagnetic layer to each other.

6. The magnetoresistive element according to claim 5, wherein at least one of the first coupling layer and the second coupling layer includes a nonmagnetic layer and two magnetic layers sandwiching the nonmagnetic layer.

7. The magnetoresistive element according to claim 1, further comprising a bias magnetic field applying layer that applies a bias magnetic field to the first and second ferromagnetic layers so that the magnetizations of the first and second ferromagnetic layers change their directions compared with a state in which no bias magnetic field is applied to the first and second ferromagnetic layers, the bias magnetic field applying layer including a third ferromagnetic layer and an antiferromagnetic layer that are stacked and are exchange-coupled to each other.

8. The magnetoresistive element according to claim 7, wherein the bias magnetic field applying layer applies the bias magnetic field to the first and second ferromagnetic layers so that the magnetizations of the first and second ferromagnetic layers are directed orthogonal to each other.

9. A thin-film magnetic head comprising: a medium facing surface that faces toward a recording medium; and a magnetoresistive element disposed near the medium facing surface to detect a signal magnetic field sent from the recording medium,
the magnetoresistive element comprising:
a first shield layer and a second shield layer;
an MR stack disposed between the first and second shield layers;
a first hard magnetic layer for setting a magnetization direction of the first shield layer; and
a second hard magnetic layer for setting a magnetization direction of the second shield layer,
the MR stack including a first ferromagnetic layer magnetically coupled to the first shield layer, a second ferromagnetic layer magnetically coupled to the second shield layer, and a spacer layer made of a nonmagnetic material and disposed between the first and second ferromagnetic layers, wherein the first and second ferromagnetic layers have magnetizations that are in directions antiparallel to each other when any external magnetic field other than a magnetic field resulting from the first and second hard magnetic layers is not applied to the first and second ferromagnetic layers, and that change their directions in response to an external magnetic field other than the magnetic field resulting from the first and second hard magnetic layers.

10. A head assembly comprising: a slider including a thin-film magnetic head and disposed to face toward a recording medium; and a supporter flexibly supporting the slider,
the thin-film magnetic head comprising: a medium facing surface that faces toward the recording medium; and a magnetoresistive element disposed near the medium facing surface to detect a signal magnetic field sent from the recording medium,
the magnetoresistive element comprising:
a first shield layer and a second shield layer;
an MR stack disposed between the first and second shield layers;
a first hard magnetic layer for setting a magnetization direction of the first shield layer; and
a second hard magnetic layer for setting a magnetization direction of the second shield layer,
the MR stack including a first ferromagnetic layer magnetically coupled to the first shield layer, a second ferromagnetic layer magnetically coupled to the second shield layer, and a spacer layer made of a nonmagnetic material and disposed between the first and second ferromagnetic layers, wherein the first and second ferromagnetic layers have magnetizations that are in directions antiparallel to each other when any external magnetic field other than a magnetic field resulting from the first and second hard magnetic layers is not applied to the first and second ferromagnetic layers, and that change their directions in response to an external magnetic field other than the magnetic field resulting from the first and second hard magnetic layers.

11. A magnetic disk drive comprising: a slider including a thin-film magnetic head and disposed to face toward a recording medium that is driven to rotate; and an alignment device supporting the slider and aligning the slider with respect to the recording medium,
the thin-film magnetic head comprising: a medium facing surface that faces toward the recording medium; and a magnetoresistive element disposed near the medium facing surface to detect a signal magnetic field sent from the recording medium,
the magnetoresistive element comprising:
a first shield layer and a second shield layer;
an MR stack disposed between the first and second shield layers;
a first hard magnetic layer for setting a magnetization direction of the first shield layer; and
a second hard magnetic layer for setting a magnetization direction of the second shield layer,
the MR stack including a first ferromagnetic layer magnetically coupled to the first shield layer, a second ferromagnetic layer magnetically coupled to the second shield layer, and a spacer layer made of a nonmagnetic material and disposed between the first and second ferromagnetic layers, wherein the first and second ferromagnetic layers have magnetizations that are in directions antiparallel to each other when any external magnetic field other than a magnetic field resulting from the first and second hard magnetic layers is not applied to the first and second ferromagnetic layers, and that change their directions in response to an external magnetic field other than the magnetic field resulting from the first and second hard magnetic layers.
